(19) United States
(12) Patent Application Publication
(10) Pub. No.: US 2014/0129267 A1
(43) Pub. Date: May 8, 2014

(54) INTERNET TRAVEL ADVICE

(71) Applicant: Miguel Carlos de Almeida Rodrigues Sarmento, Lisboa (PT)

(72) Inventor: Miguel Carlos de Almeida Rodrigues Sarmento, Lisboa (PT)

(21) Appl. No.: 14/116,362

(22) PCT Filed: May 7, 2012
(86) PCT No.: PCT/EP2012/058359

§ 371 Date: Jan. 23, 2014

Related U.S. Application Data
(60) Provisional application No. 61/483,989, filed on May 9, 2011.

(51) Int. Cl. G06Q 50/14; G06Q 10/02

(52) U.S. Cl. CPC G06Q 50/14; G06Q 10/02
USPC 705/5

(57) ABSTRACT

A web portal in which a person requests a proposal for a travel product/service with a quotation and opportunity to accept the proposal.

This invention relates to internet/travel, and more particularly to a method of internet travel agencies provide as a customized service to customers.

Indeed, with the growth of the Internet, the final customer has had access to much more information on the available offer at different planned destinations and can and also have access to much more competitive prices, offered directly to final customers by the various entities that participate in the sector, whether Airlines, Hotels, Rent-a-car, etc.

This resulted in an increasing difficulty for Travel Agencies to add value to the information provided to the final customer and an ever narrower margin on its offer, due also to the fact that many service providers, having found a means to contact the end customer directly, ceased paying or paid significantly reduced commissions to travel agencies. It is increasingly the case that a travel agency, having done all of the work of finding the services requested by its customers and after having suggested them to the customer, the said customer is able to obtain a price that is the same, if not lower than that obtained by the agency, which prevents it from being remunerated for all of the time spent and the risk assumed, when subsequently the customer simply uses the information provided to it by the agency and contracts the services directly.

Such aspects have resulted in a shrinking share of the trips organized by Travel Agencies, a loss of their profitability and a significant increase in dissolution and bankruptcy of Travel Agencies.

Travel agencies have not been able to resolve this problem, hence the significant number of bankruptcies and closures in the sector and, as the end customers become more familiar with Internet use, the agencies have greater difficulty in adding value, as they are unable to provide information that is more useful or credible than that which the final customer is able to obtain through his/her own searches nor offer more competitive prices.

As a consequence of the above, travel agencies have witnessed a reduction in the scope of their activity, and most significantly, in relation to individual clients. This is so because, in practice, they can only sell to people who do not know how to use the internet, simply do not have the patience to do searches, or lack the time to check if they can get the proposed services at a lower price and are therefore willing to pay more. In relation to Incentive or Group Trips, the problem is not as acute as in the first case. The searches that the agency's client carries out are paid for to someone, given that they are companies and in both case, it is a question of bulk purchases and the offer made available by service providers is intended mainly for the final individual customer/traveller (FIT).

There is nothing in the market to assist travel agencies in being more competitive and adding value. Outgoing agencies have tried to use the services of Wholesalers in the American market, but this has not proved to be a solution either, as they cannot offer competitive prices nor sufficient information to be able to provide tailor-made proposals to their customers and while the time spent has diminished, a great deal of time is still required.

Many travel agencies have created Internet sites where they publicize their presence and what they do, but this has not produced results because on the one hand, they are unable to reach the public at large and even when they can, it is unsuccessful, as they are unable to convey the idea, as explained above, of added value. The larger ones generally launch group travel programs where they are more likely to be able to offer competitive prices. However, being group trips they have a very rigid format with all of the inherent disadvantages.

There is nothing available on the Internet, which assists travel agencies in offering individual clients trips which are tailor-made to fit their desires at competitive prices and with a guaranty of quality.

### SUMMARY

The present invention describes systems and methods used in the Web Portal in which the final customer, rather than choose directly from an offer which is available on the site, indicates that he/she wishes to receive a proposal and quotation for what he/she is looking for and have the possibility of acquiring the products/services that are proposed.

Embodiments of the invention can include one or more of the following features. In the Portal, four different entities can participate to conclude the business transaction, namely: final customer, specialist in organizing travel to other destinations (the Outgoing agency), the specialist in organizing travel in the market in which it operates (Incoming agency) and the final service provider (hotels, restaurants, rent a cars, etc.). The method used in the Portal can permit the final customer to purchase all of the services/products he/she needs at the end destination, as well as to receive all of the information desired to be able to enjoy the trip more. In the method used in the Portal only the information which offers the greatest cost/benefit can be displayed, and not an abundance of existing offers, as well as allowing such information to be classified according to different aspects. In the method used in the Portal the information required to conclude the transaction can successively be sent from one participant to another by means of a click. The method used in the Portal can defend the interests of the final consumer, due to:
motivating the Outgoing agency presenting the proposal to provide good service, given that the higher the level of satisfaction of the final customer, the more requests that will be sent to it by the Site.
motivating the Incoming agencies to propose good products at good prices as they will be competing with other agencies in the same destination market. In addition, because the site will display, in a very transparent manner, in relation to each service/product, their respective characteristics, price, and the level of satisfaction of final clients who previously used/purchased them. Similarly, these agencies also have to provide a first rate service in as much as they will evaluated by the Outgoing agencies and said evaluation is made available to Outgoing agencies when the time comes for them to select an Incoming agency.
24 h customer support at the end destination

The method used in the Portal can promote only such part of the offer that has the best cost/benefit ratio and, which further allows it to be an important sales channel for the services/products it promotes and thereby have good prices from its final suppliers and consequently, offer good prices to the final customer. The method used in the Portal can enable whoever introduces products/services, with an additional cost, to request that automatic translations be reviewed by native translators. The method used in the Portal can allow the Outgoing agency to invoice the final customer in any local currency, by merely indicating the exchange rate, in relation to the Dollar or Euro, they wish to use. In the method used in the Portal products rated below 6 on a scale from 1 to 10 can be removed from the Portal, as another means of quality assurance. In the method used in the Portal wherein each proposal can be accompanied by a description of the destination indicating, among other things, what is fundamental to see and do. For the payment used in the method used in the Portal the final customer can pay the Outgoing agency, the Outgoing agency can pay the Incoming agency and the latter pays the service provider. Method used in the Portal can comprise distribution of requests received through the Site among Incoming agencies and which takes into consideration the rating attributed by the agencies and by final customers and the traffic each agency brings to the Portal. The method used in the Portal can permit Outgoing agencies to select the Incoming agency with which it will work on a given order, included in the table below containing the different Incoming agencies selected for that destination and a series of columns with the information required for a decision to be made. The method used in the Portal can allow Outgoing agencies, after having chosen the Incoming agency, to visualize the types of services/products the agency can provide and that results from, with a click on the name of the selected agency, having access to the following table in which they are listed. The method used in the Portal can allow Outgoing agencies, after having selected the Incoming agency, and having viewed the types of services/products the latter can provide, with a mere click, to see a table with the services/products available in that group, classified according to various aspects, with information on each one displayed, in some cases, by means of specific symbols, as can be seen in the table below. The method used in the Portal can allow Outgoing agencies, after selecting the Hotel, to see the types of rooms available and the price for the intended stay, and which consists of clicking on the name of the hotel, after which the following information is displayed, when the hotel has no rooms available for that date, a red “X” appears. The method used in the Portal can allow Outgoing agencies, after having selected the type of hotel room and before confirming their selection, to view, in detail, the information on the chosen hotel and room, as well as the information that will be sent to the final customer for confirmation or rejection of the Outgoing agency's selection. This is done by clicking on the name of the selected room, whereupon, a table with information immediately appears. The method used in the Portal can allow price comparison with other sites and which consists of clicking on the “search sites” button and selecting one to view from the list displayed, whereupon the Portal automatically links to the selected site. The method used in the Portal can confirm the choice of service/product and integrate it in the proposal to be made to the final customer and which consists of clicking on the “Add to Cart” button found in the previous table. The method used in the Portal, wherein after all of the services/products have been selected by the Outgoing agency and proposed to final customer, an e-mail is automatically sent to customer with a proposal which includes a brief description of the destination and of the proposed products/services. For this purpose, in the order file, it is only necessary to click on the “Comply” button. The Method used in the Portal can add additional information to the product/service. This is done by clicking on the product name in the “Product List” and making a selection in the window that opens, as shown in the following figure. The method used in the Portal can identify orders that have actions pending. The orders can be placed automatically in several folders, from the moment it is received until it is executed, according to the phase it is in. As the agency knows which folders contain actions to be executed, it is easy for them to identify the orders that need to be handled, especially since, following its name, there are two numbers, wherein the second indicates the number of orders that are in the folder. The method used in the Portal can identify orders which have pending actions overdue. Each folder can have two numbers, following its name, the first of which indicates the number of orders for which actions are overdue. The method used in the Portal, whereby, if at the end of the trial period, the agency agrees with the proposed price, it will pay this amount from the first day it joined. If it does not agree, there is nothing to pay and it may use the system for a further 15 days free of charge.

Further features and advantages of the systems and methods according to the present inventions are as follows:

The services/products available on the site can be selected by Incoming agencies who are specialists in that destination, agencies which were themselves selected from among several candidates.

Agencies or services/products that score lower than 6 on a scale from 1 to 10 can be removed from the Site, which, together with the fact that agencies compete with each other in a very transparent environment, results in all of the participants systematically seeking a good cost/benefit ratio.

Each product offered can have an indication of the number of reviews it received in the last 6 months as well as the average rating score it received. It is also possible to view the history of these reviews in detail.

In order to resolve the problem of lack of competitiveness/profitability of travel agencies, a site should be created in which Outgoing agencies can acquire all of the services/products that a traveller may need to use/purchase at the intended destination. In order to guarantee that such purchases are made under the best cost/benefit terms, the solutions mentioned above were applied to the site. To increase the volume of business of participating travel agencies, the site is also open to the final customer so that agencies can recover a large number of final customers who have since begun to purchase their trips directly on the internet from the final service provider.

### DETAILED DESCRIPTION

How the Site Works

The site has an area for which access is limited to participating Travel Agencies. Only the Incoming or Outgoing agencies may be members.

Outgoing Agencies

They seek all of the information they require by destination in order to respond to their customers' inquiries.

Incoming Agencies

At the respective destination, they offer the services/products they have selected in accordance with the rules defined by the Member Travel Agencies.

How They Proceed

Outgoing Agencies, upon receipt of an inquiry, enter into the restricted access area of the site, where they can access their workstation. Once there, they open a folder for that inquiry and select the intended destination. On selecting the destination, a summary table appears with all of the Incoming agencies selected for that destination and with all of the information required to select their preference. By clicking on the selected agency, a table appears with the types of services offered by the chosen agency. By clicking on the type of service sought, the various available options are displayed. Upon clicking on the selected option, information on the selected product can be seen in detail. In order to make a proposal to the customer, they need only click on the button “add to cart” for the services/products they wish to select and they are automatically included in the shopping cart which was created automatically. It is possible to indicate the desired details in relation to any product, when they have concluded the selection of the services/products needed, they click on “comply” and an e-mail is automatically sent to the client with a proposal. The e-mail contains all of the information which the customer needs to choose, accept or refuse the suggestions made. The customer needs only to return the e-mail, highlighting the suggestions chosen or requesting additional suggestions. Subsequently, clicking on a button, the Outgoing agency automatically sends the selected Incoming agency the request. The Incoming agency confirms if everything is available and informs the Outgoing agency that everything is in order and that the deadline for payment is “x” days. At this point, a payment request is sent to the final customer. After the payment circuit is complete, vouchers are issued, all automatically with a click on the respective on screen button. After the journey has been completed, the final customer receives a satisfaction questionnaire in order to rate all of the services used. The Outgoing agency also receives a questionnaire to rate the services provided by the Incoming agency. The results of the questionnaire are communicated to the 2 agencies involved in the trip and the classifications received will automatically update the overall rating for the respective services/products and agency.

The system also has the following specificities:
It is possible throughout the entire process for travel agencies to exchange messages with each other. These messages are automatically saved in the respective order file.
It is further possible for the Outgoing agency to send e-mails to its final customers, which are automatically saved in the respective order file.
Outgoing agencies may choose the currency in which they wish to make their purchases from among; Dollar, Euro, Pound Sterling or Yen.
Outgoing agencies may automatically invoice in their own currency, by merely defining the exchange rate to be used against the Dollar or Euro.
Communication between agencies in the Portal is in English, however, communication between Outgoing agencies and their final customers on the one hand and between Incoming agencies on the other, may be in one of the 8 languages available through the Portal. If the Incoming agencies so request, the automatic translations that the Portal provides may be reviewed by the team of translators of the Travel Agency member network.
Customer assistance for the final customer at the destination 24 h/24 h, provided by the selected Incoming agency, which will provide the information needed free of charge.

Below, the system, the site and methods are described in more detail and with reference to the figures.

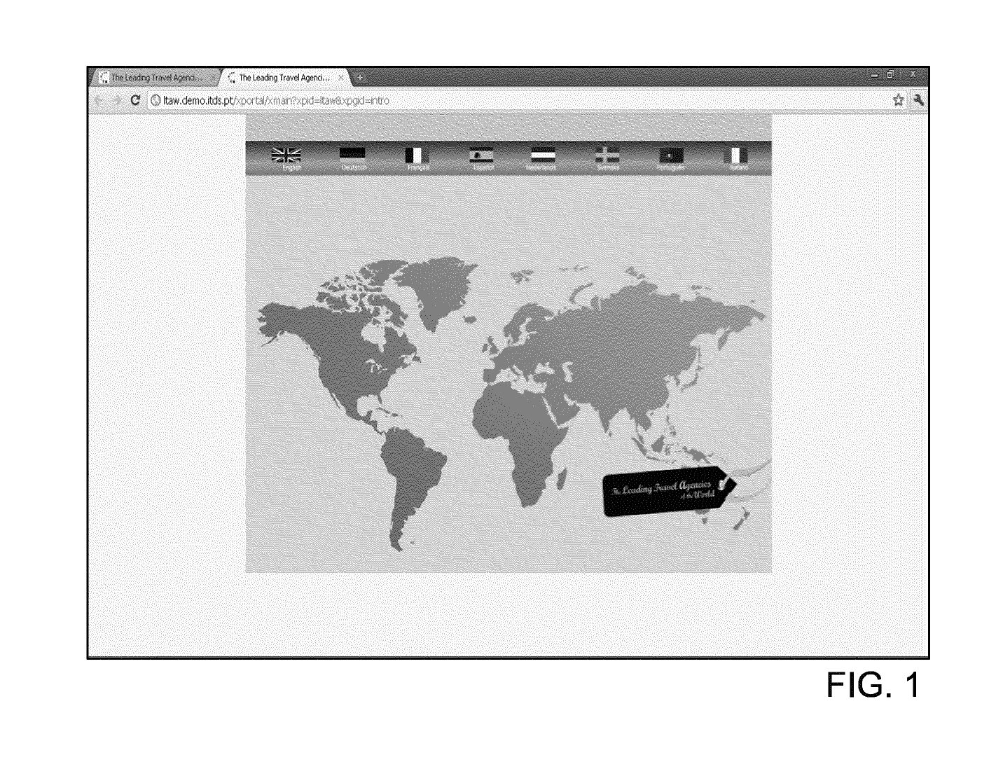

This site is intended for the general public and for travel agencies. The general public can access the site through www.thetripiwant.com. Upon entering, FIG. 1 is displayed, where the user can choose between various alternatives (8 at the present); the language in which he/she wishes to be contacted in, merely by clicking on the corresponding flag, after which text appears which states the name of the Travel Agencies network in question and inviting the user to make a non-binding request for an estimate for the desired trip and that said estimate will be presented by a travel agency located in the area of the user's residence, and supported by a specialized travel agency at the selected destination. After clicking, a screen will appear where the user fills in his/her name, e-mail address and country of residence. There is also a box in which the user will describe the characteristics of the desired trip.

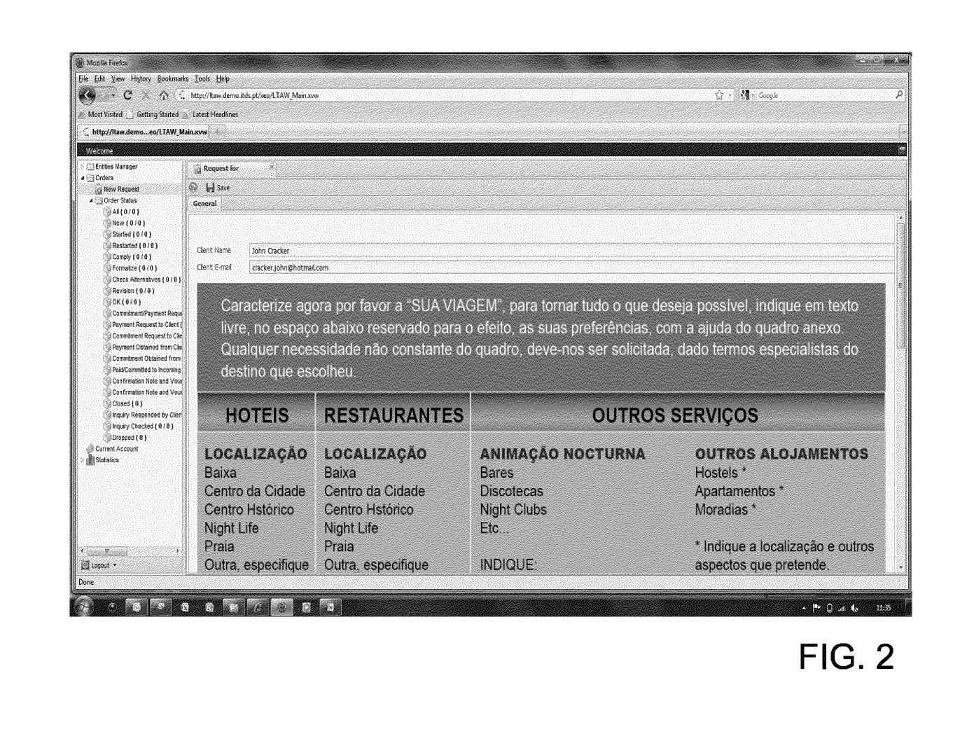

After having read and accepted the Portal's terms of use and privacy policy, the user clicks on the “submit” button and the request is immediately sent to a travel agency in the city where the user lives and that is a member of the Portal. Where there are several agencies in that city, the system distributes the requests by rotation. In a subsequent phase, such distribution will take into account the classification obtained by agencies as well as their business turnover within the Portal. O system also automatically sends the final customer an e-mail, confirming receipt of a request for an estimate. Upon receipt of a request from a customer, Outgoing agencies must open the folder “New Request” and fill out the request form (FIG. 2), beginning by placing the customer's name and e-mail address.

Next, in the box for free text, the agent will write all of the information relating to the customer's inquiry. Finally, the agency should save the order, which, in addition to being recorded will automatically be saved in a folder marked “New”. If the order has come directly from the site, it will have gone directly to the “New” folder. From this point on the process is the same for both situations.

FIG. 2:

Upon clicking “save”, a new order is generated with an individual number , which will be attached to the order for the entire process and which will serve as a reference of the request for the Incoming Agency selected. The system automatically generates an e-mail to the customer, thanking him/her for the inquiry and informing said customer that a proposal will be sent very soon. This e-mail is identical to e-mails sent previously to customers who have made inquiries through the site.

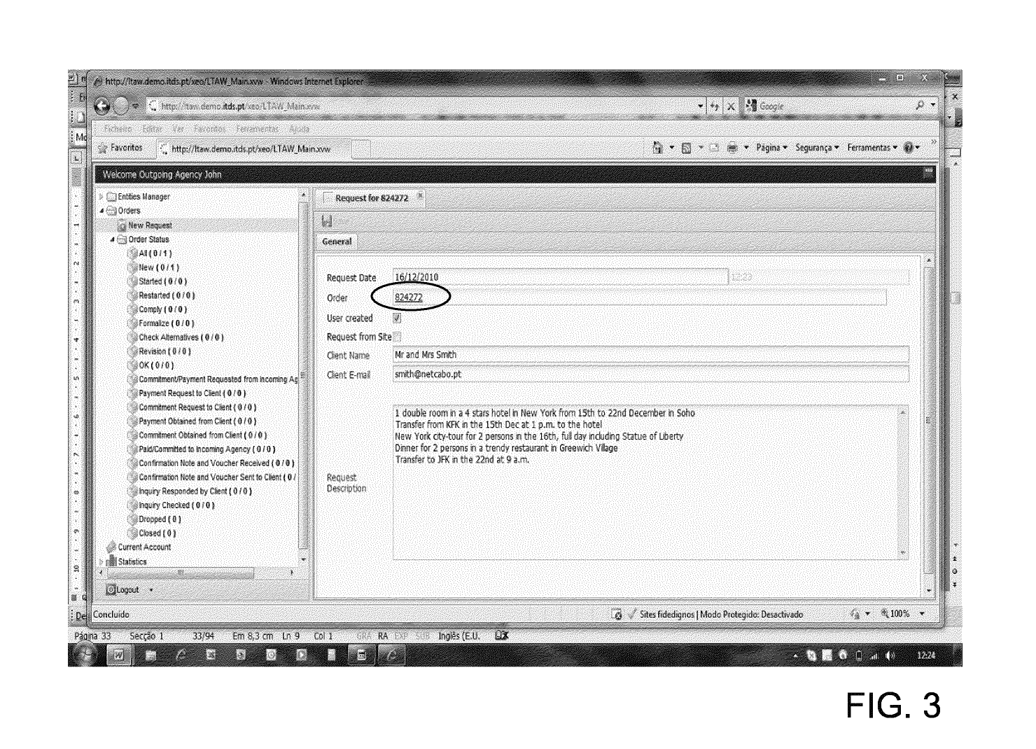

FIG. 3:

By clicking on the order reference number, the new order file is opened again, which is where the entire request will be processed.

The agent begins by completing all of the information pertaining to the order: the names of the passengers should be placed in the “Passenger(s) Name “box, following which the agent should fill in the “destination” and “departure date” boxes. The dates are always inserted by means of the pop-up calendar. In the “Comments” box important information about this specific reservation can be included, i.e. “Customer needs documentation 15 days prior to departure”. Payment details can be filled out later.

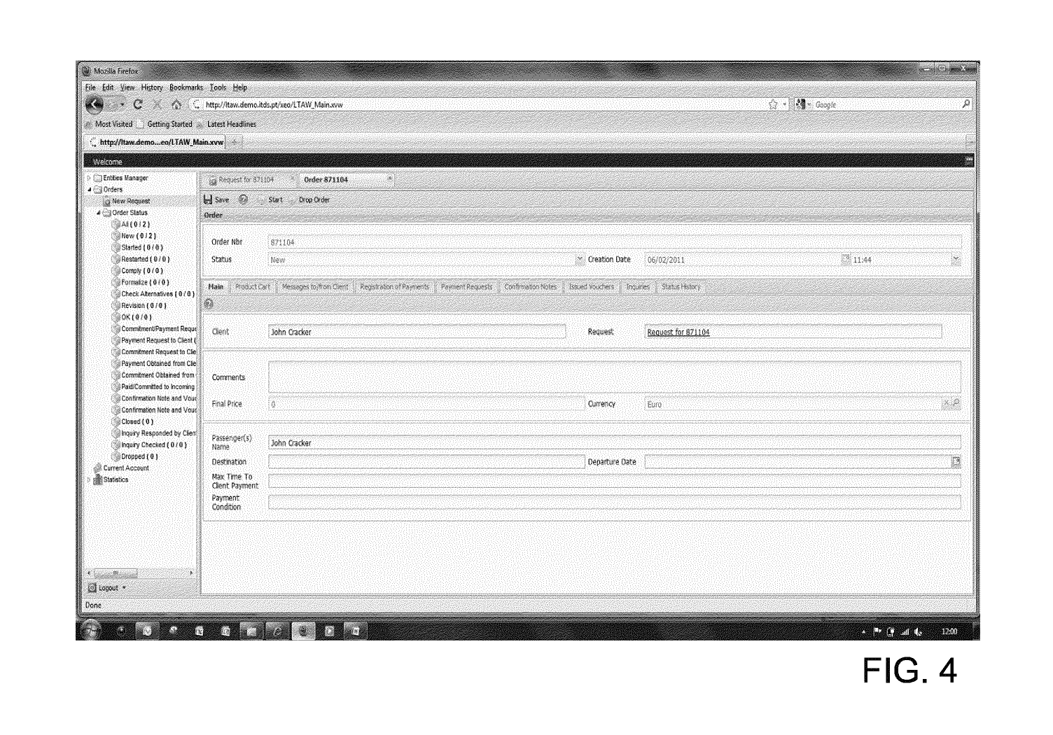

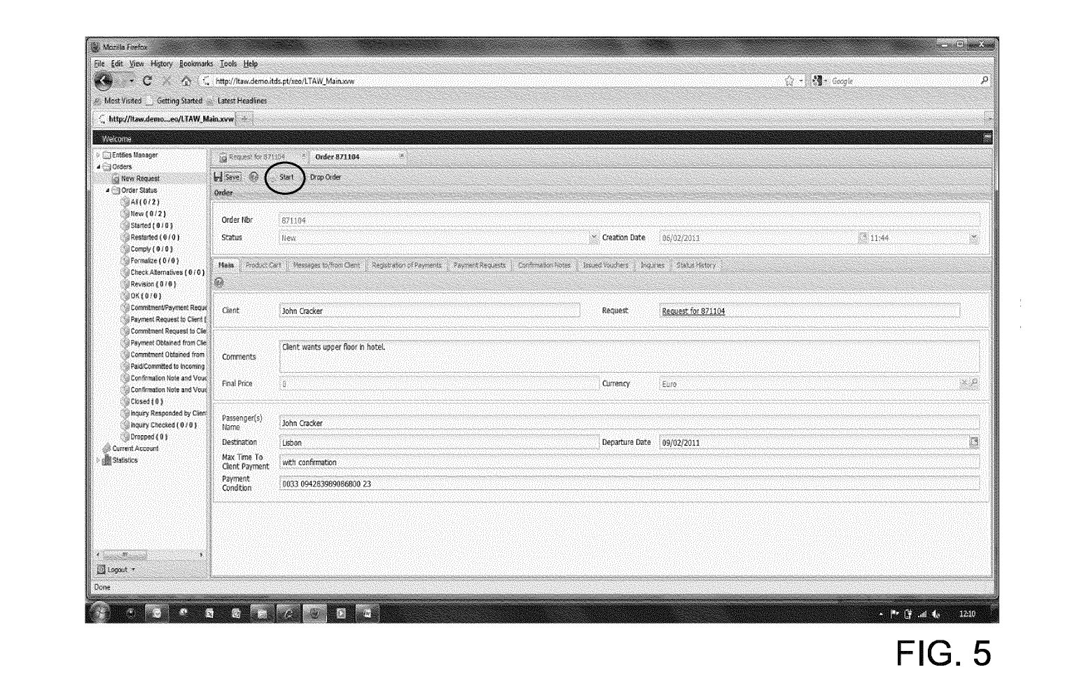

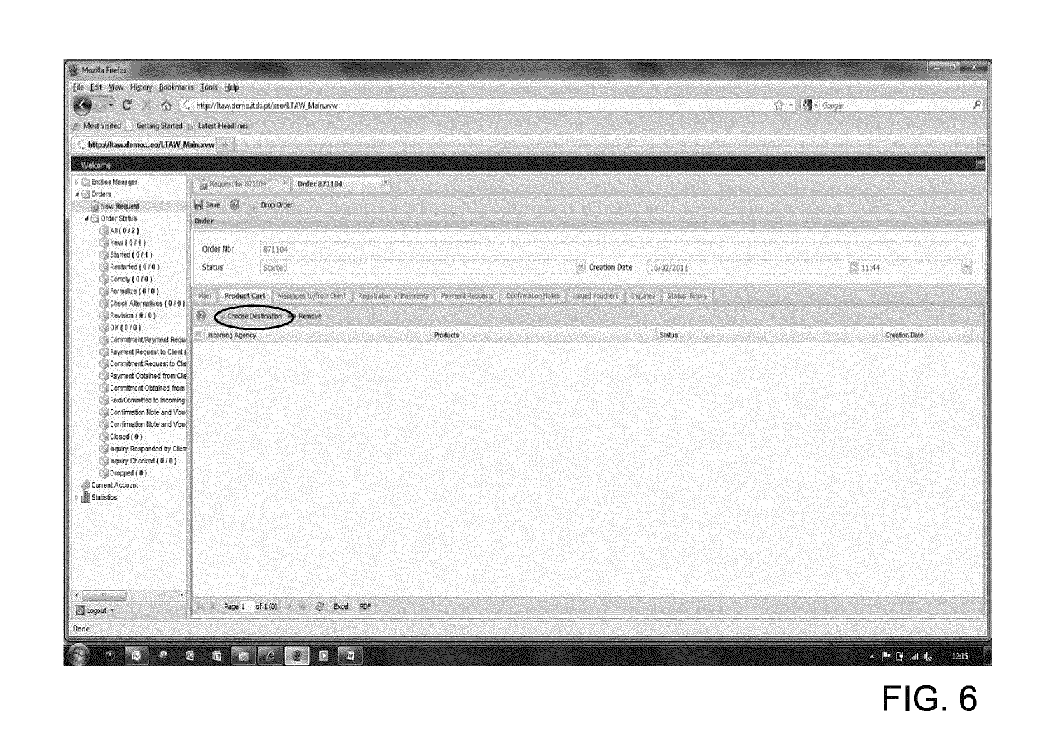

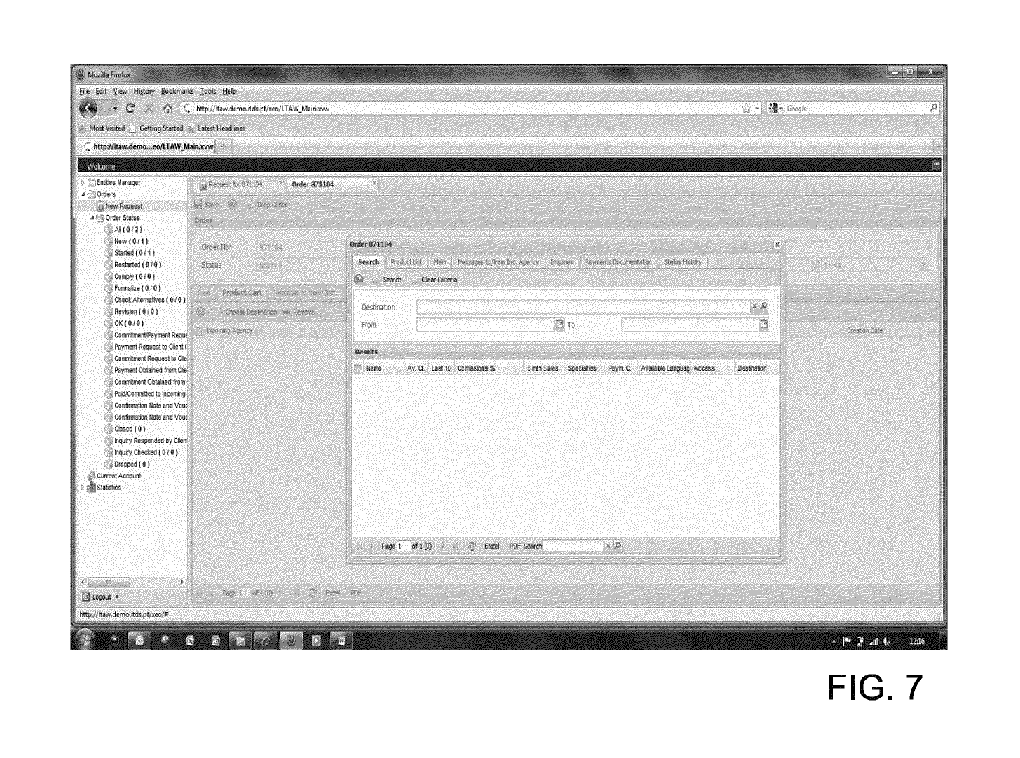

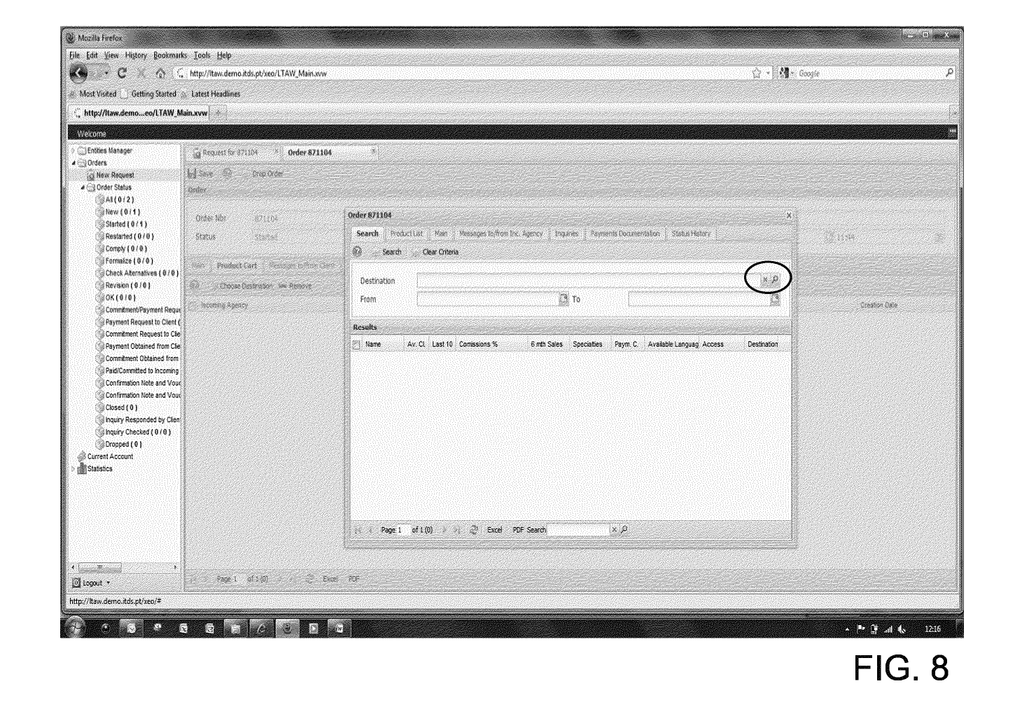

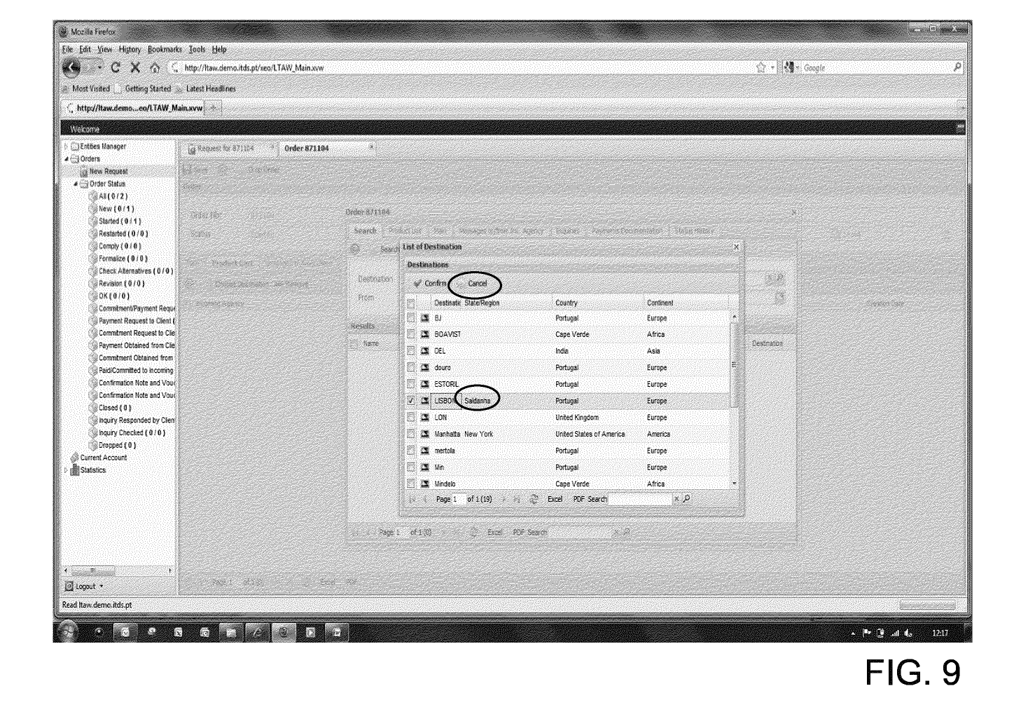

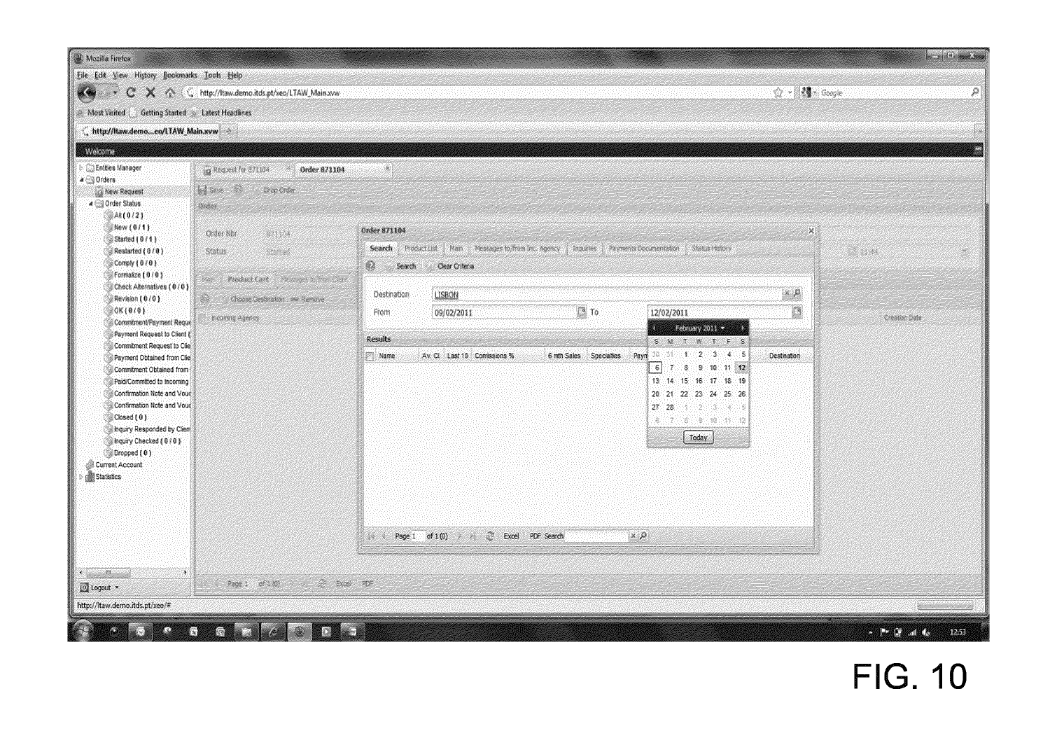

FIGS. 4 to 10:

Click on start and upon entering the “Product Cart” tab, click on “Choose Destination”. A new screen appears which needs to be filled in. Filling in the “Destination” box—by clicking on the “magnifying glass”, the intended destination can be found. The destination is selected, marking it and clicking on “Confirm”. Now the dates need to be selected by using the pop up calendar. At the end, by a click on “search”, the Portal can begin to search for agencies which offer services at this destination.

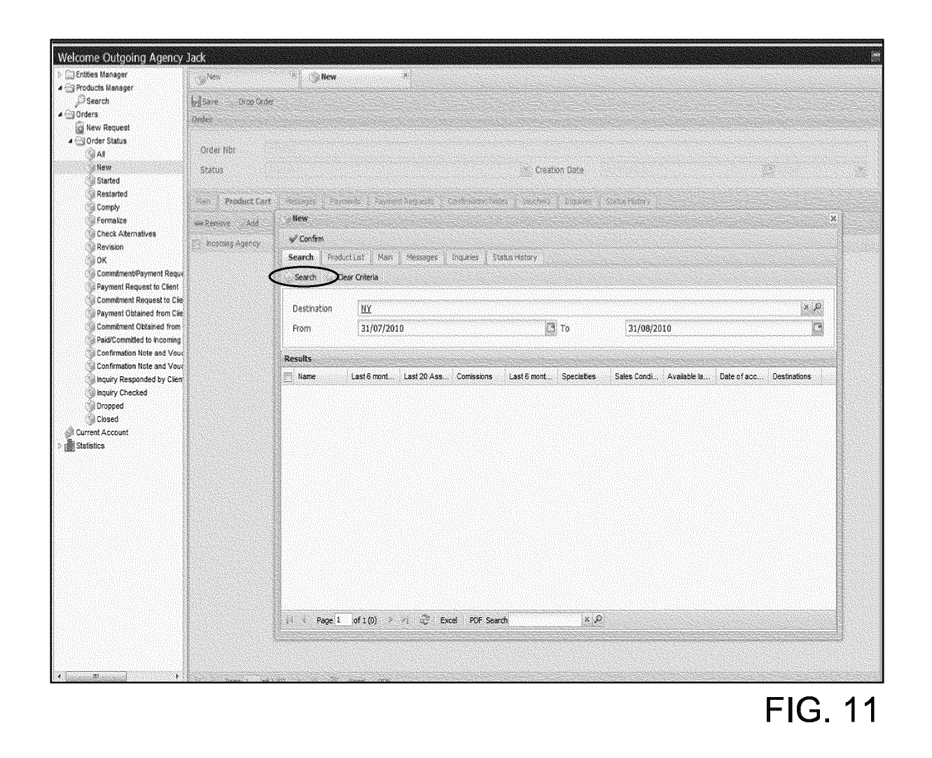

FIG. 11:

Subsequently a table is displayed with the choice of agencies and containing the relevant information for the Outgoing agency to select the most appropriate Incoming agency, in other words:
The average classification score received over the last 6 months by Outgoing agencies which have already used it
The last 10 scores
Commissions paid to Outgoing agencies for this type of service
Business turnover through the Portal in the last 6 months
The specialization of each agency
Payment terms
Languages in which the products offered are available through translations by the network's team of translators or, alternatively, by the automatic translator available through the Portal
Date on which agency became a member of the Portal
Destinations it represents

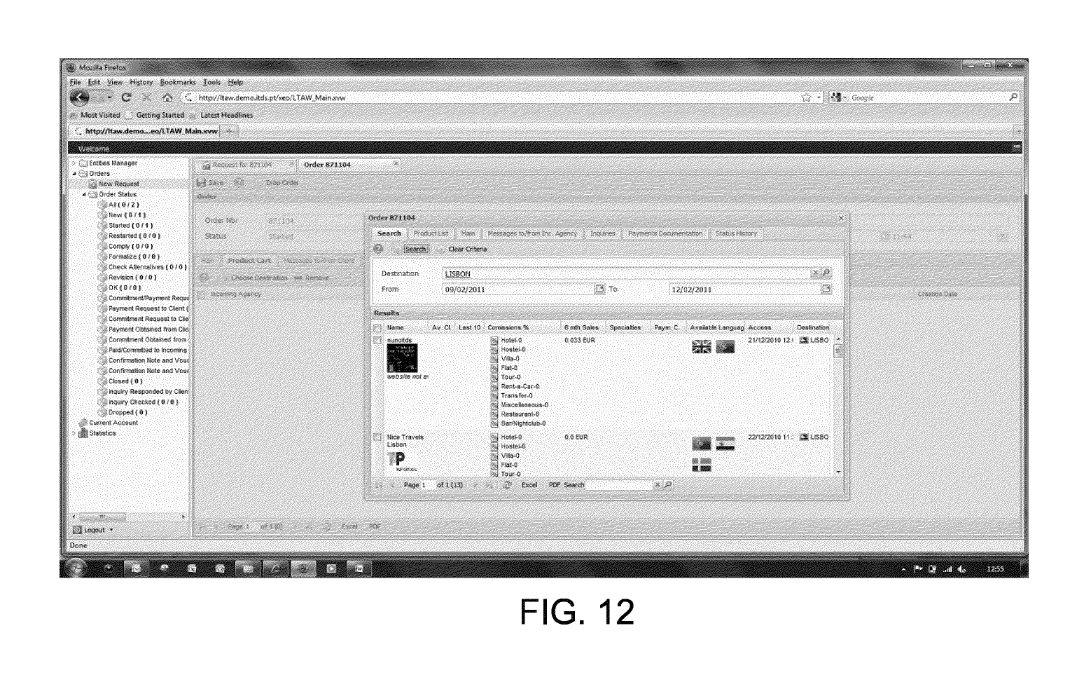

FIG. 12:

After marking the agency to select it, a table appears showing all of the types of products it offers.

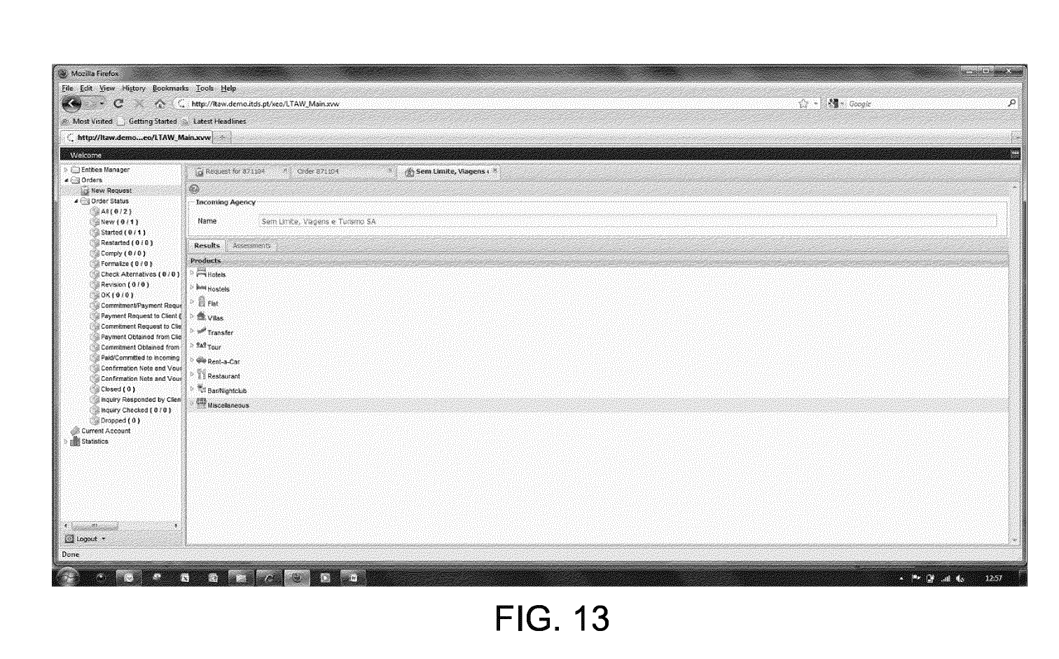

FIG. 13:

By clicking on the desired product, a new summary table opens with all of the offers that the agency can provide for this product. It should be noted that the practice of this Portal, rather than providing a large number of offers available, is to only make available such offers with the best cost/benefit ratio. The table contains several columns containing the differentiating characteristics of each, in order for the choice of product/service to be simple and quick. For example, in the case of hotels the following references are made:
category
location
type of hotel
type of customer
number of reviews received by customers in the last 6 months
average score for the reviews
number of rooms
with or without a pool
with or without Health Club
with or without restaurant
with or without handicap access
with or without rooms for smokers
with or without parking
with or without internet and if it is charged for or free access
availability of meeting rooms
availability of golf courses
if pets are accepted

If there are no rooms available for the selected dates, the first column will contain a red X.

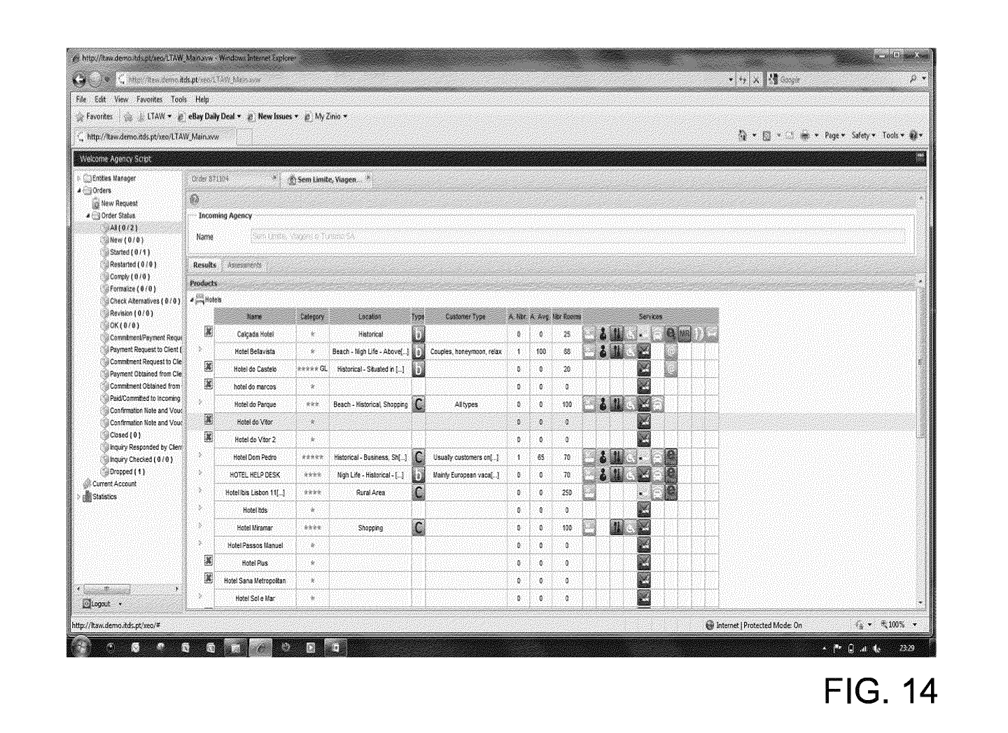

FIGS. 14 to 16:

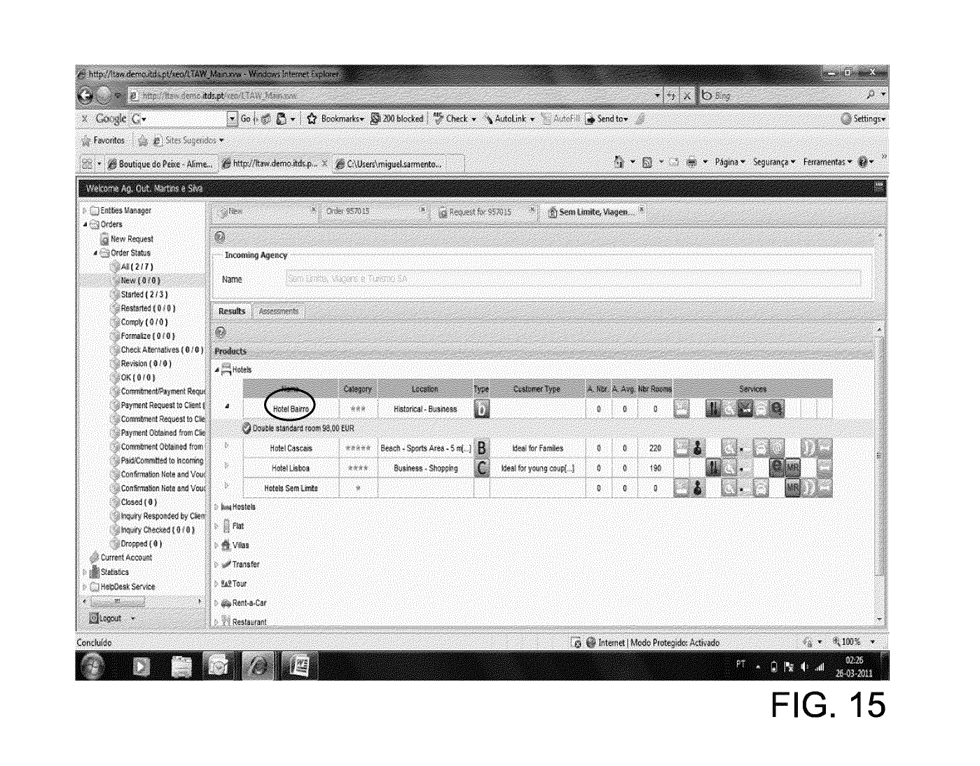

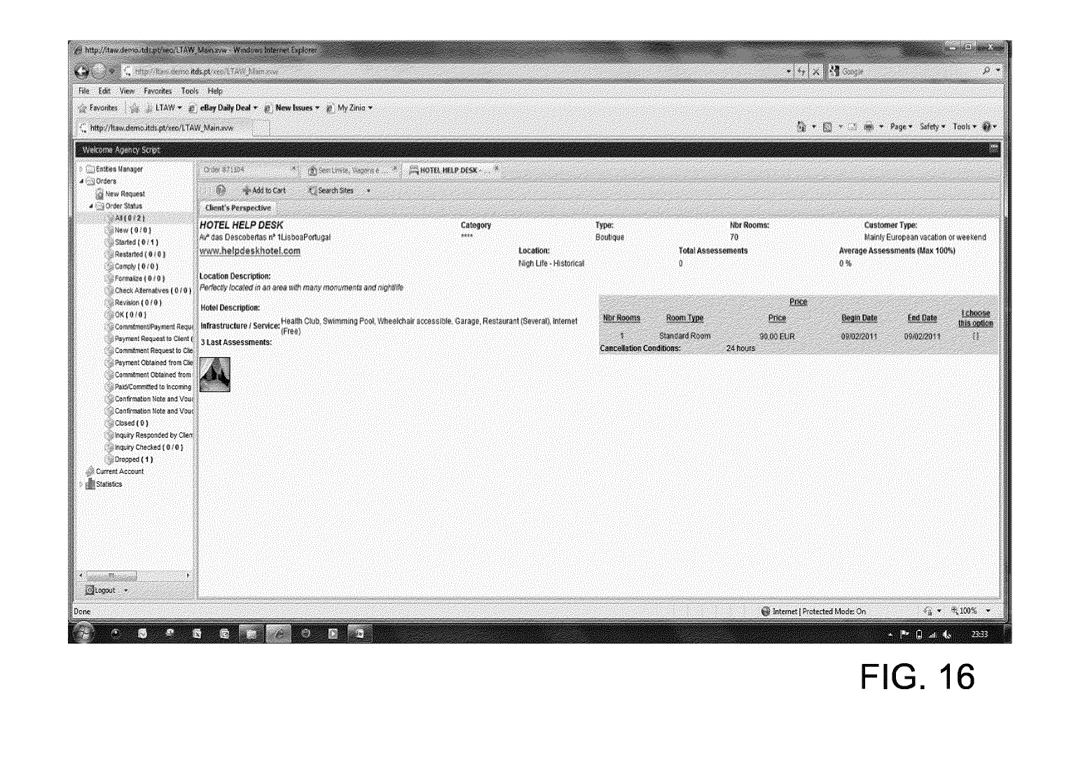

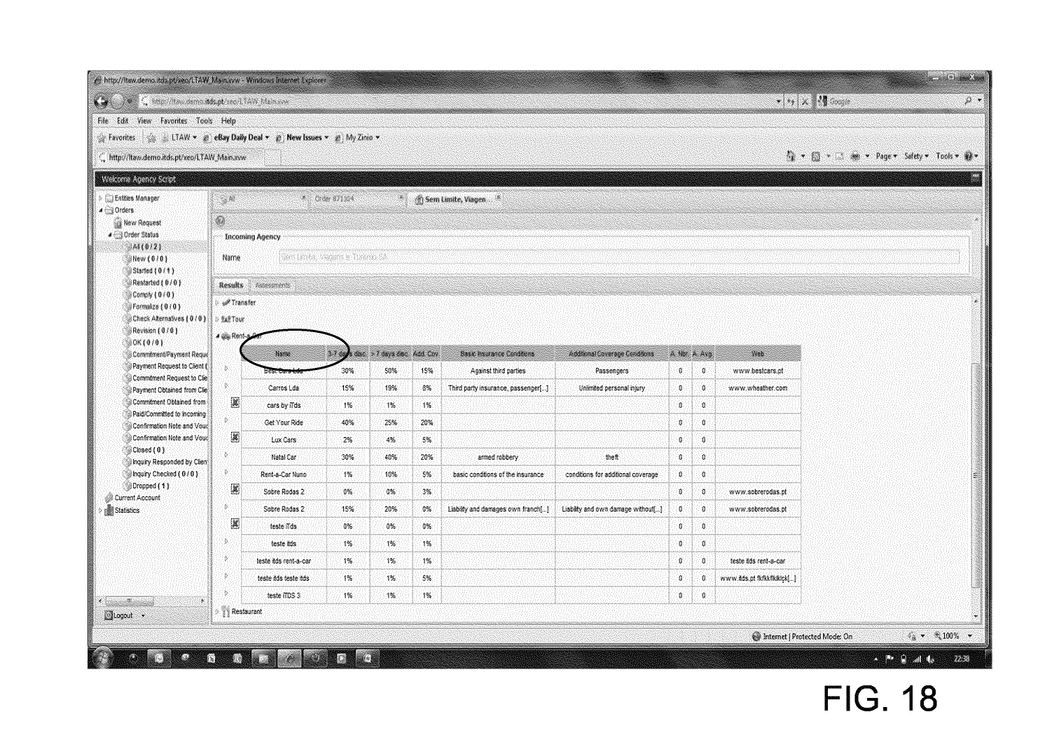

The hotel which is most suitable for meeting the customers' preferences is selected. By clicking on the arrow in front of its name, a new line appears for each type of room available, which also contains the price of the stay (FIG. 15). By clicking on this line, even more detailed information about the hotel appears; its services, address, website, the reservation details and even photographs (FIG. 16). The system automatically permits the user to check the price available for the same hotel, under the same conditions, on different sites, in order to test if the price offered on the site is the lowest available on the net. To this end, the user must click on the “search sites” button. If a lower price is found, evidence of this can be sent to the Incoming agency, who undertakes to match this price, provided all of the requirements of the search are met. This button is available on the screen in FIG. 18 and only in the case of hotels and rent-a-car companies. In order to continue with the purchase, click on the “add to cart” button and this product is automatically added to the customer's shopping cart, in other words, to the order.

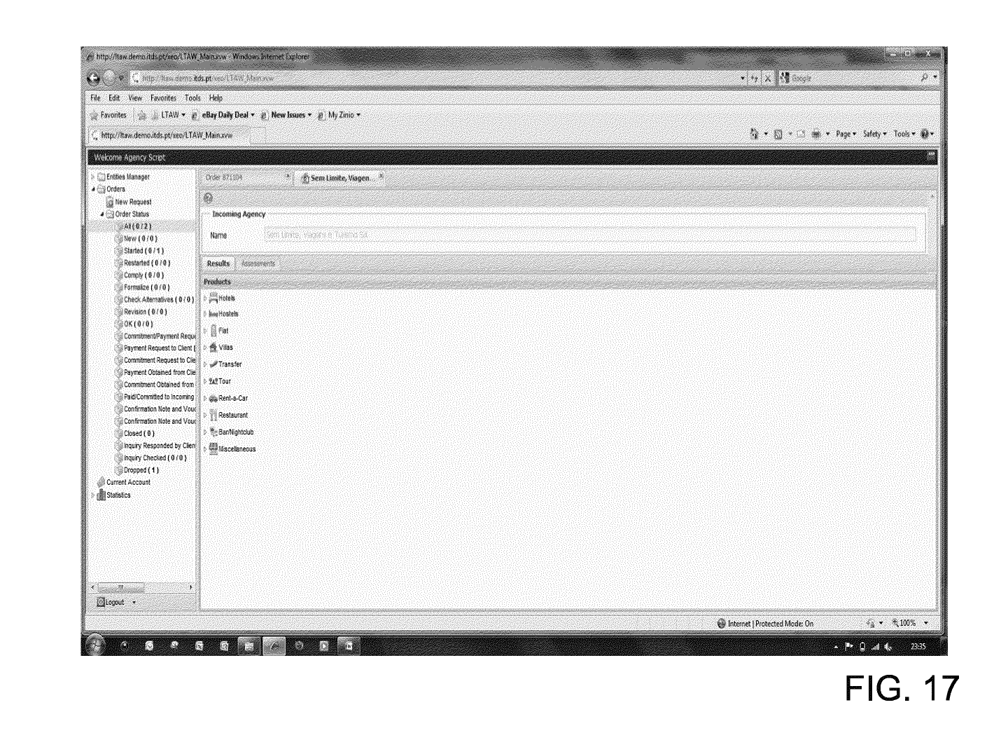

FIG. 17:

The user can then return to the table containing all of the Incoming agency's services, so that other services or products can be selected.

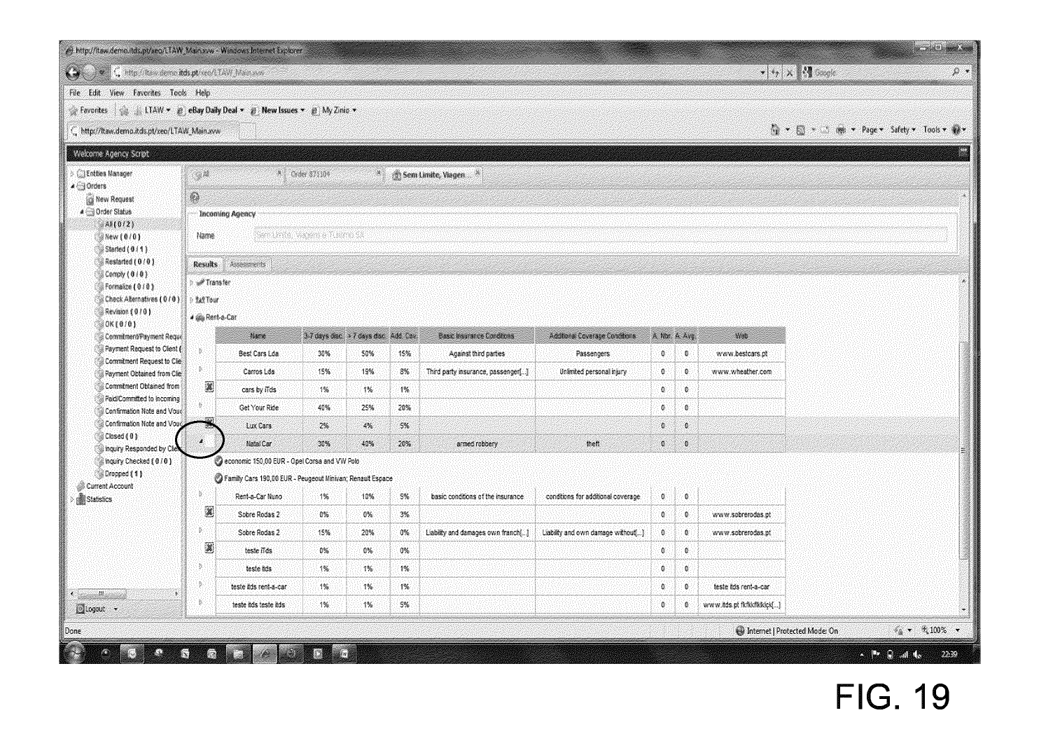

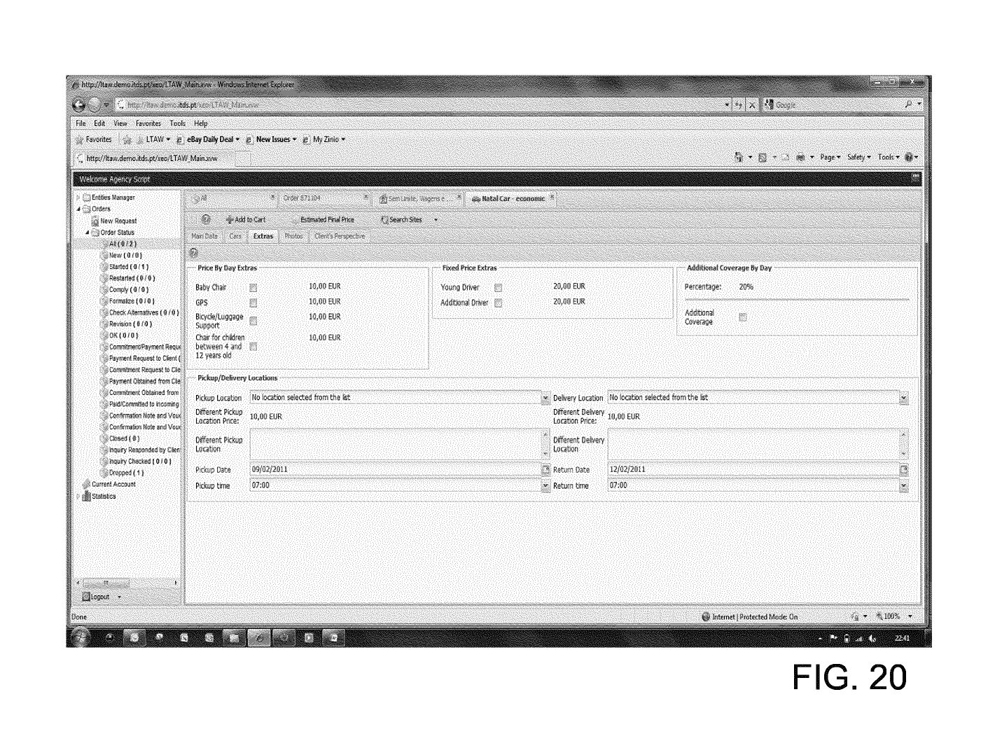

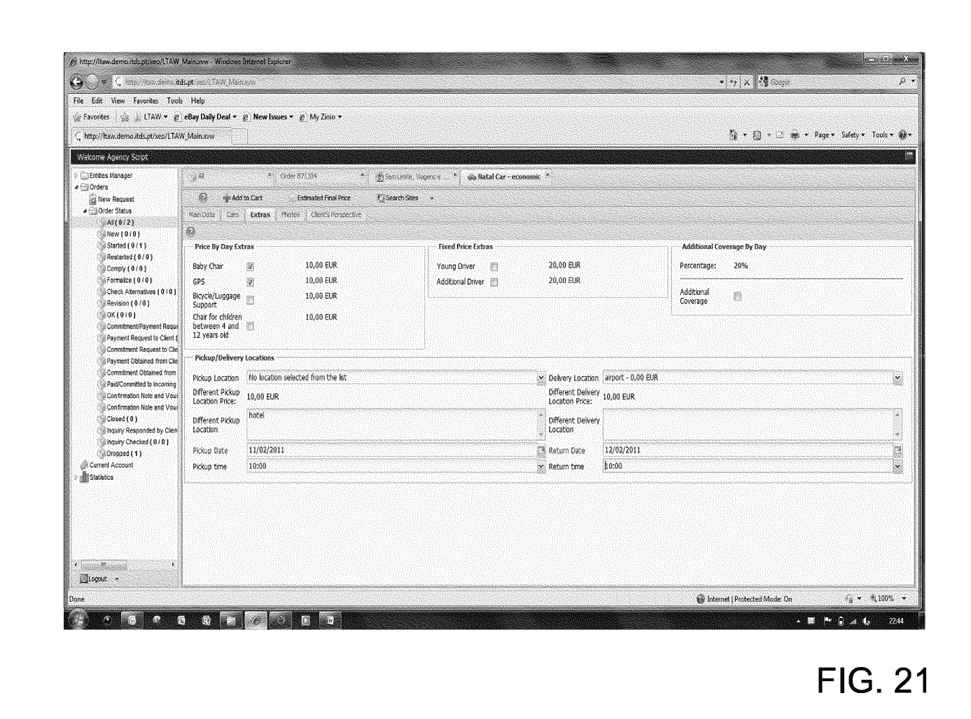

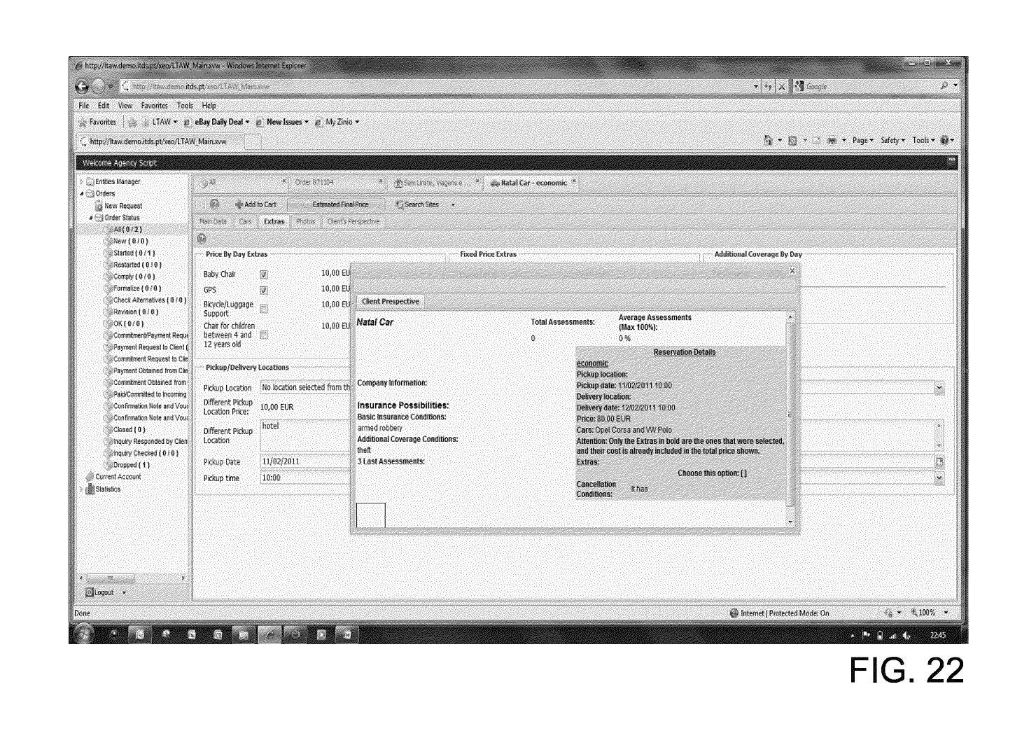

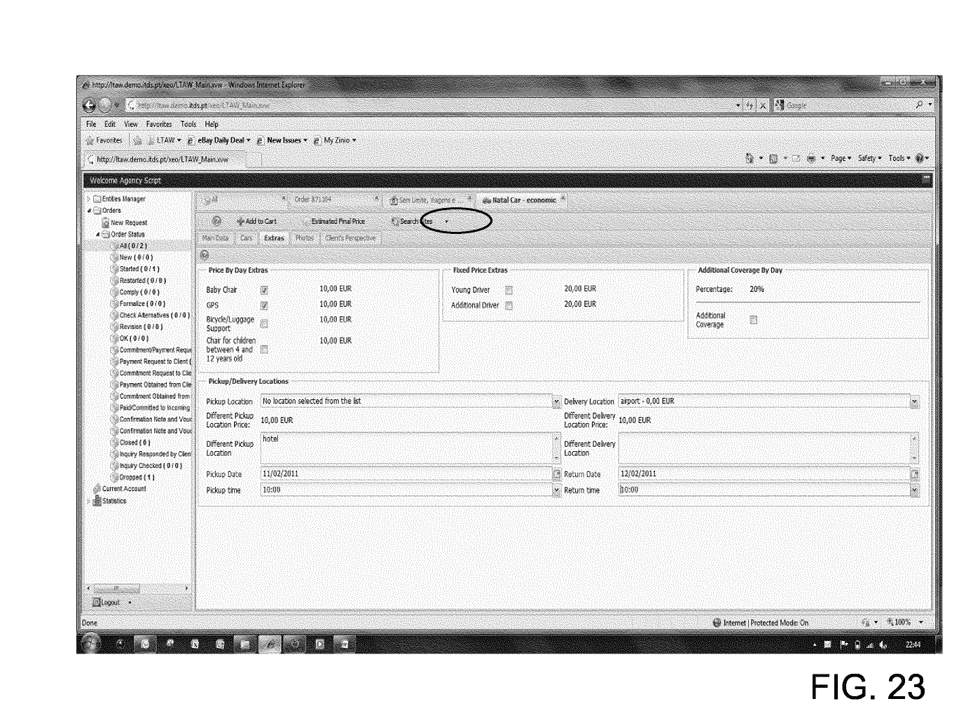

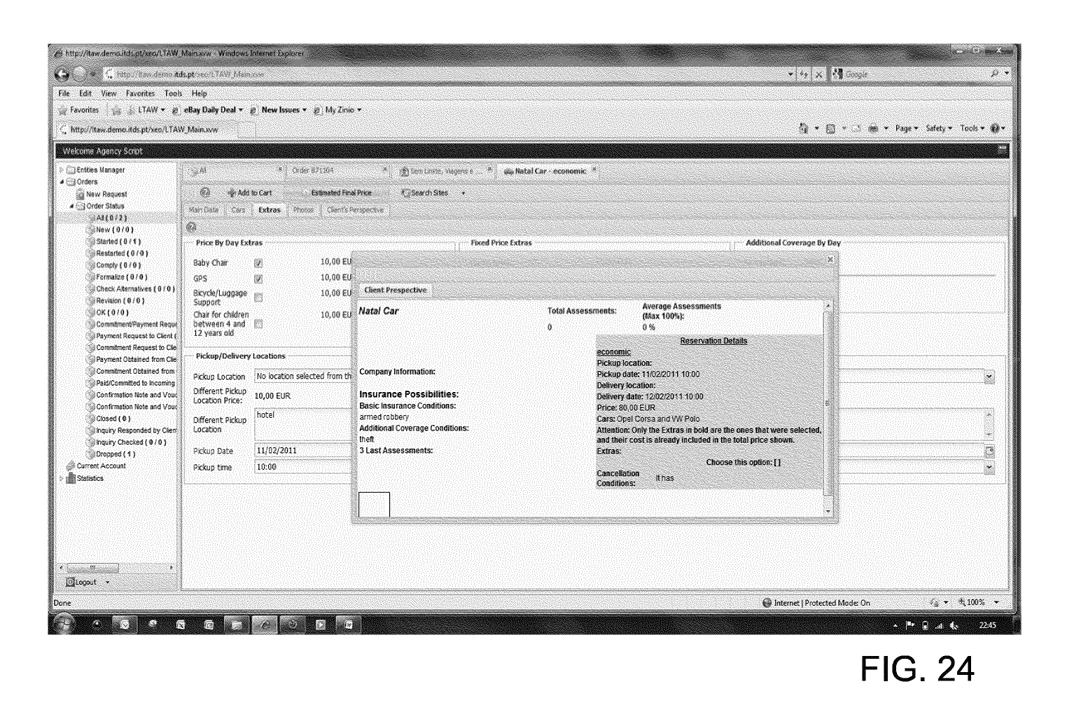

FIGS. 18 to 24:

For example, the customer may also ask for a Rent-a-Car reservation with pick-up at the hotel and airport return. By clicking on this product type, in this case Rent-a-Car, the agency can Access all of the companies with which the Incoming agency works. First, the rent-a-car company that offers the best terms is selected, by clicking on the arrow in front of its name. Upon clicking, a line appears for each car group available at that Rent a Car, with the name of the group, together with the principal models which comprise this group and base price for the intended rental. The car desired by the customer is selected, by clicking on it. The following table then appears, in which all of the desired extras are indicated, as well as reservation details. From there it is possible to access all of the information on the car: Main Data, Extras, Description and Photos. The time and place of pick-up and delivery of the car may also be selected. Once all of the details have been filled in, it is possible to obtain a quote, by clicking on “Estimated Final Price”. The “Search Sites” option is also available here, which allows the user to confirm that the price offered is the lowest available on the net. The desired product is selected by clicking “add to cart” which is then added to the final proposal.

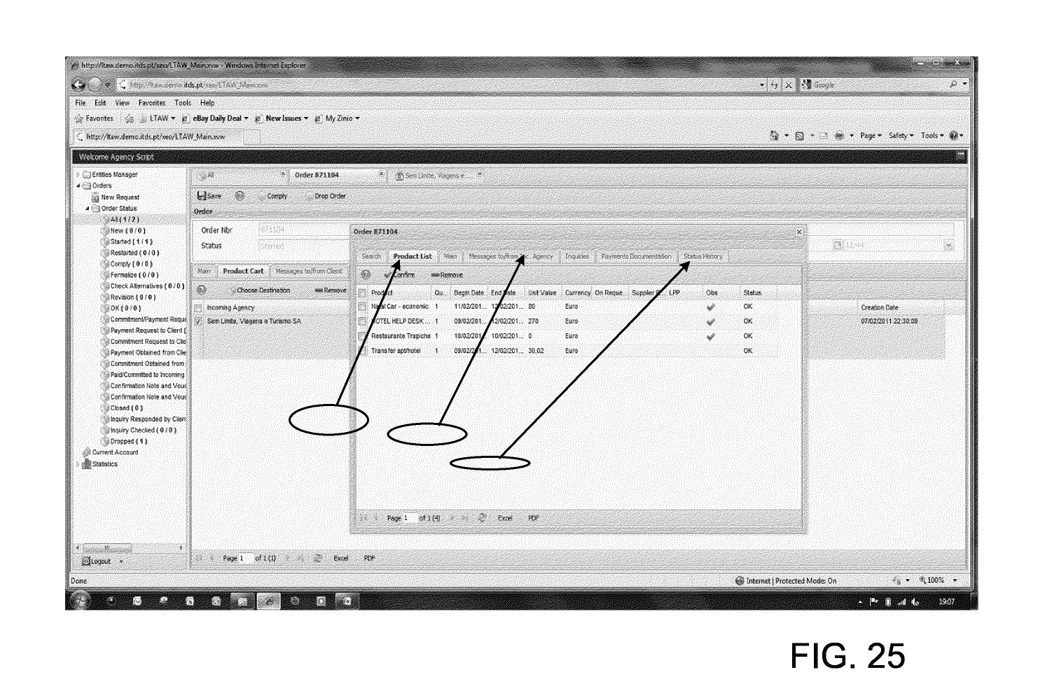

FIG. 25:

If the customer wants more products, such as reservations for Tours restaurant, all of the previously described steps are repeated, clicking on “add to cart” each time in order to add the products to the customer's shopping cart.

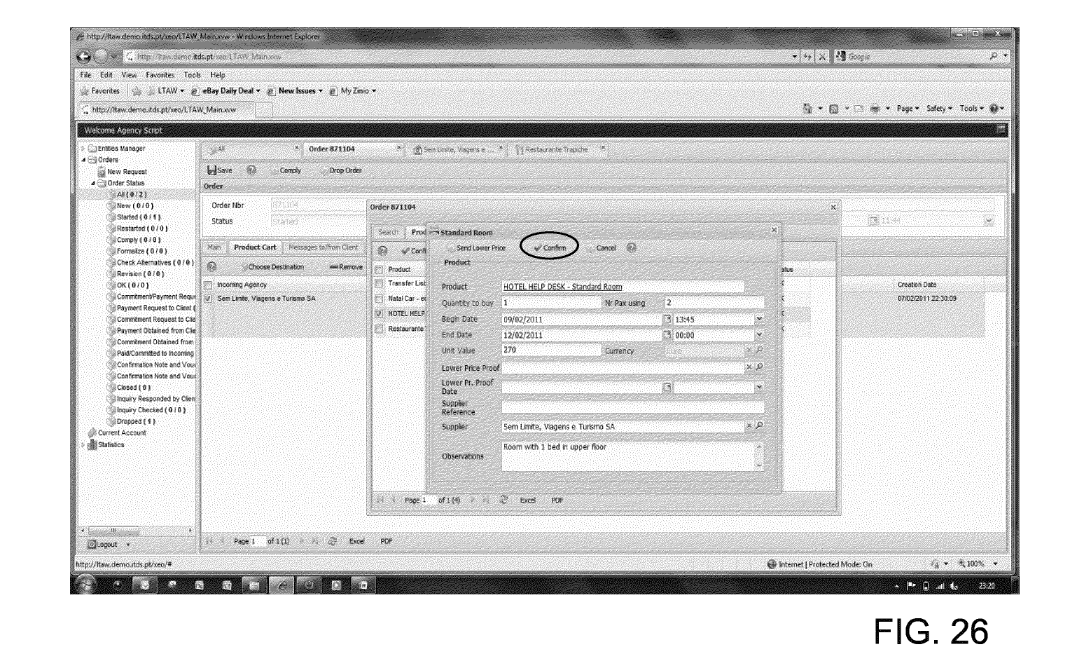

FIG. 26:

The shopping cart contains all of the products the customer ordered. The products must be finally confirmed, by opening the “Order Nr.” window and, within it, the “product list” window. Click on the green arrow to “Confirm”.

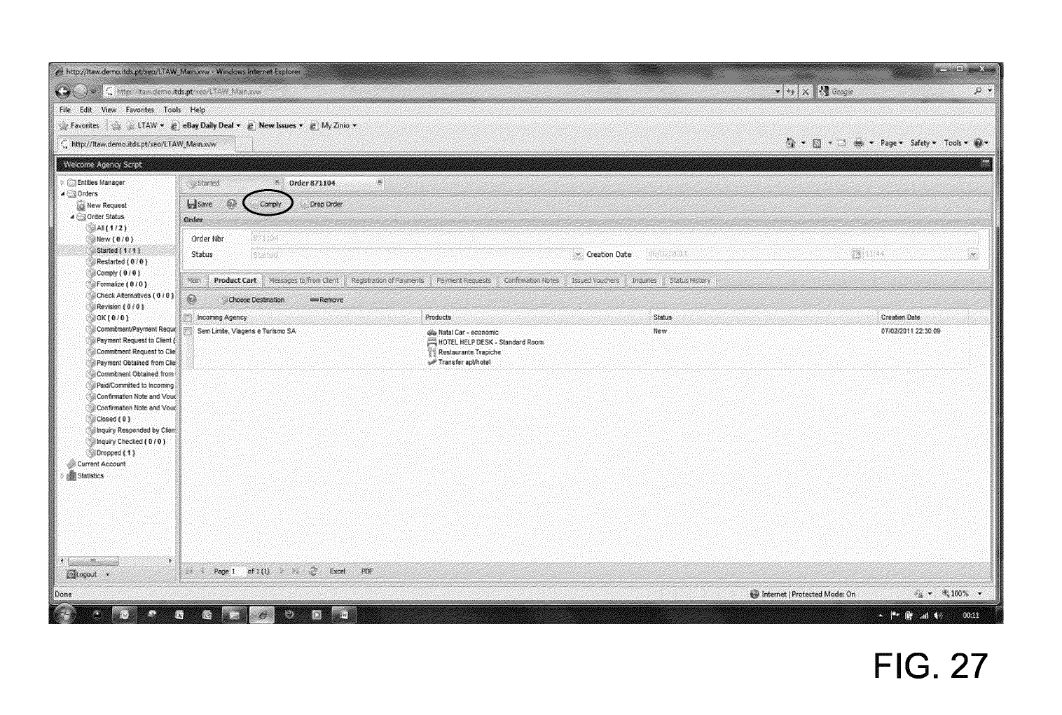

FIG. 27:

It is now necessary to indicate in detail what is intended in relation to each of the products. Still within the “Product List” window, each of the products can be opened in order to be customized. To customize the hotel, the number of rooms and guests must be indicated as well as the time and dates of arrival and departure. Any comments that are thought to be important can also be added, for the hotel's information, such as room near elevator, etc. At the end, the “Confirm” button is clicked, for the information to be saved.

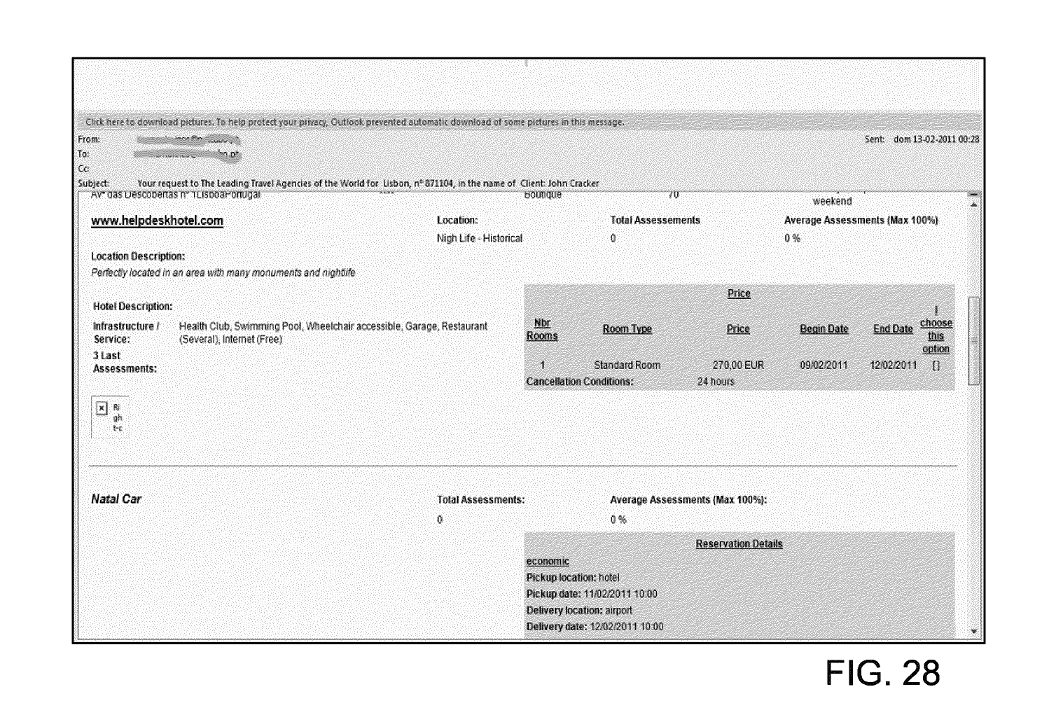

FIG. 28:

The same needs to be done for the other services. In the case of restaurants the time of arrival and confirmed date needs to be inserted. It is important that at the end of each alteration, the “Confirm” button be clicked.

After all of the products have been customized, and it has been verified that they have all been loaded on the system, the “Comply” button on the top part of the form is clicked.

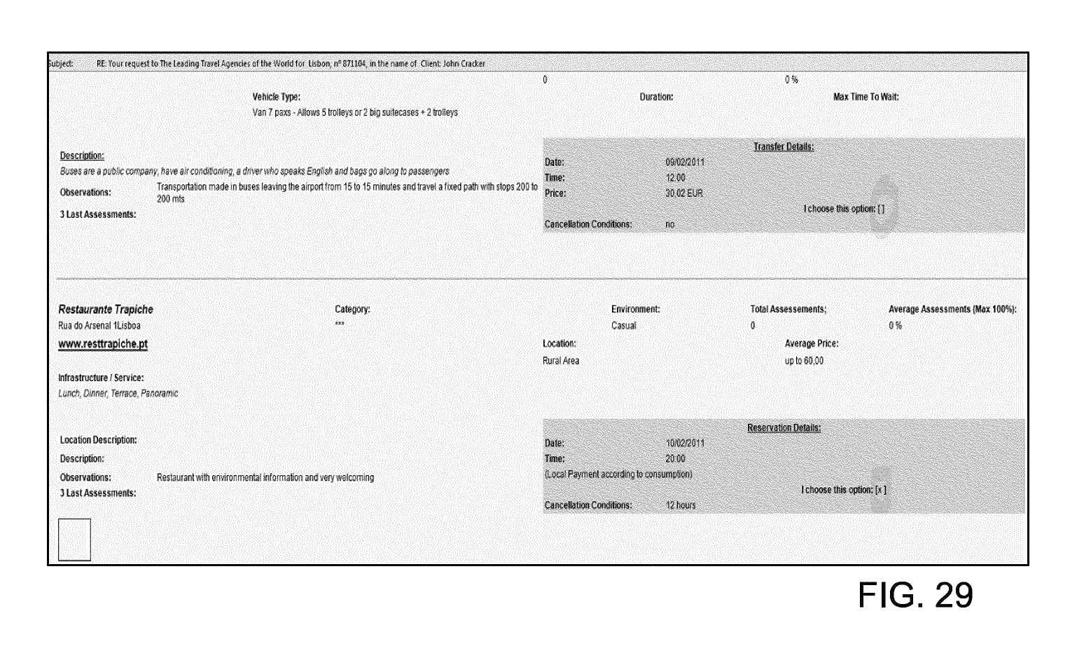

FIG. 29:

The proposal is automatically sent, via e-mail, to the customer.

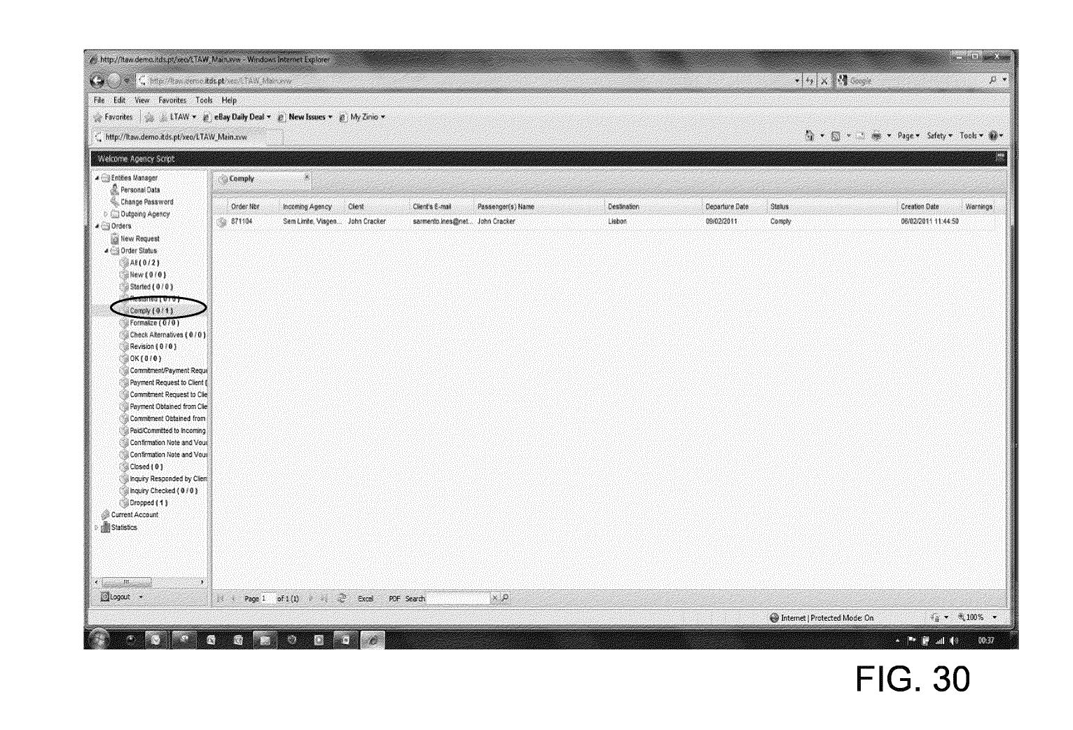

FIG. 30:

The customer replies to the e-mail, selecting the desired options.

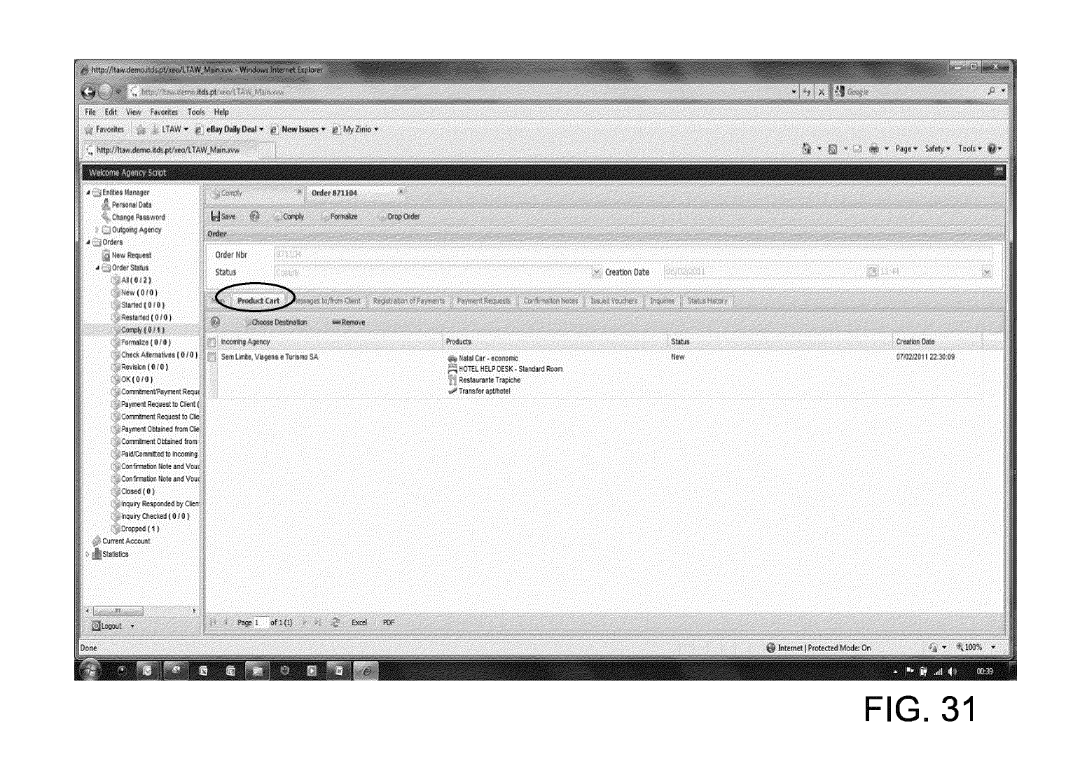

FIG. 31:

After receipt of this e-mail, an order file is opened which can be fetched from the “Comply” folder or by the order number.

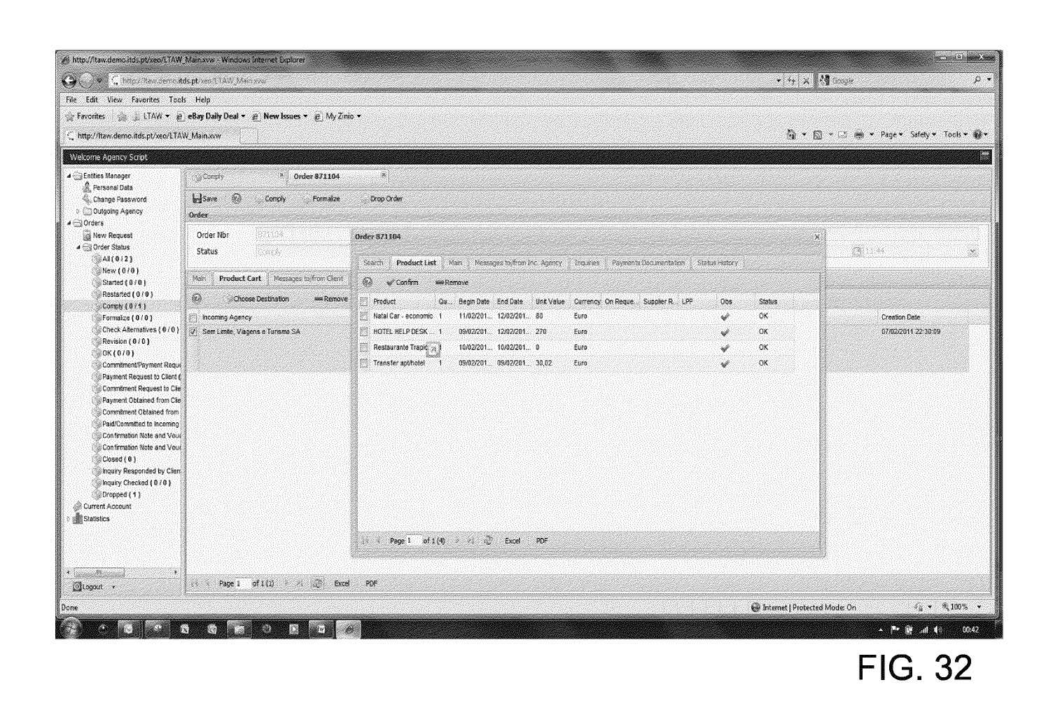

FIG. 32:

The order is opened by clicking on it, and then the “Product Cart” window is opened.

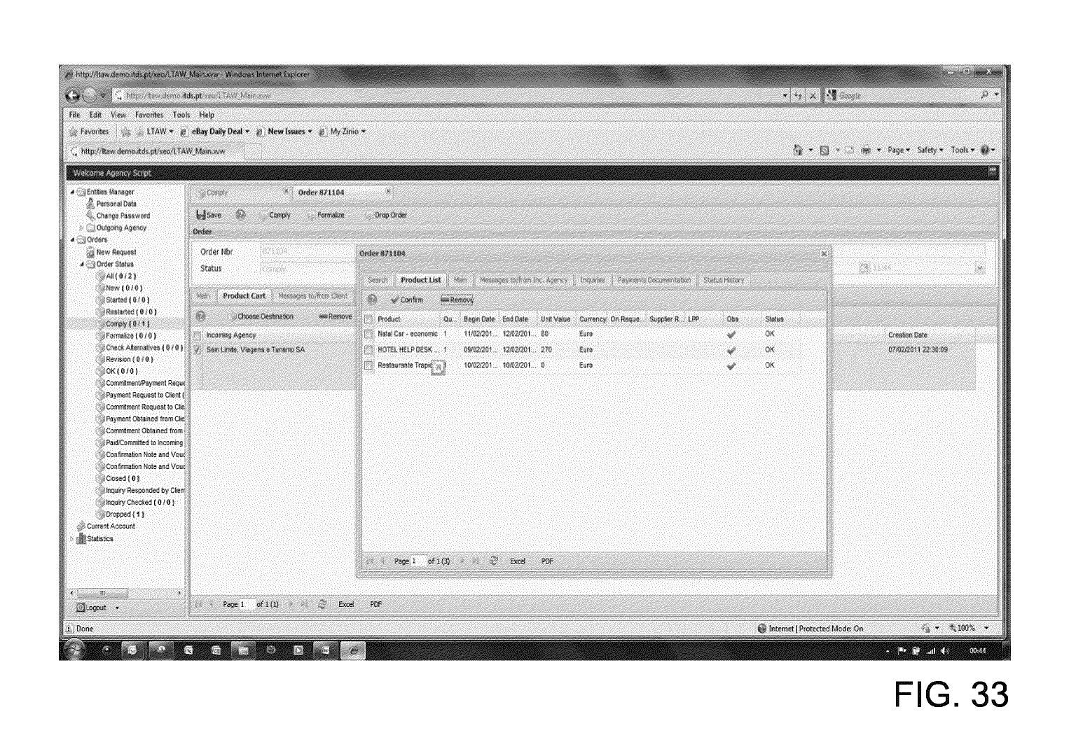

FIG. 33:

By double-clicking on the agency, the shopping cart can be viewed. Once opened, it needs to be customized in accordance with the order and e-mail from the customer. This is achieved by double clicking on the products, removing the products that the customer has decided he/she does not want, and making the remaining amendments requested by the customer in relation to the products in the shopping cart. It is also possible to add new products to the shopping cart, provided they are form the same Incoming agency. It is a rule of the Portal that only one destination agency can be selected per order. This is to ensure that there is a single agency that will be responsible for providing all of the information to the customer regarding that destination and that when the journey is made, the customer will have 24 h/24 h local support as needed.

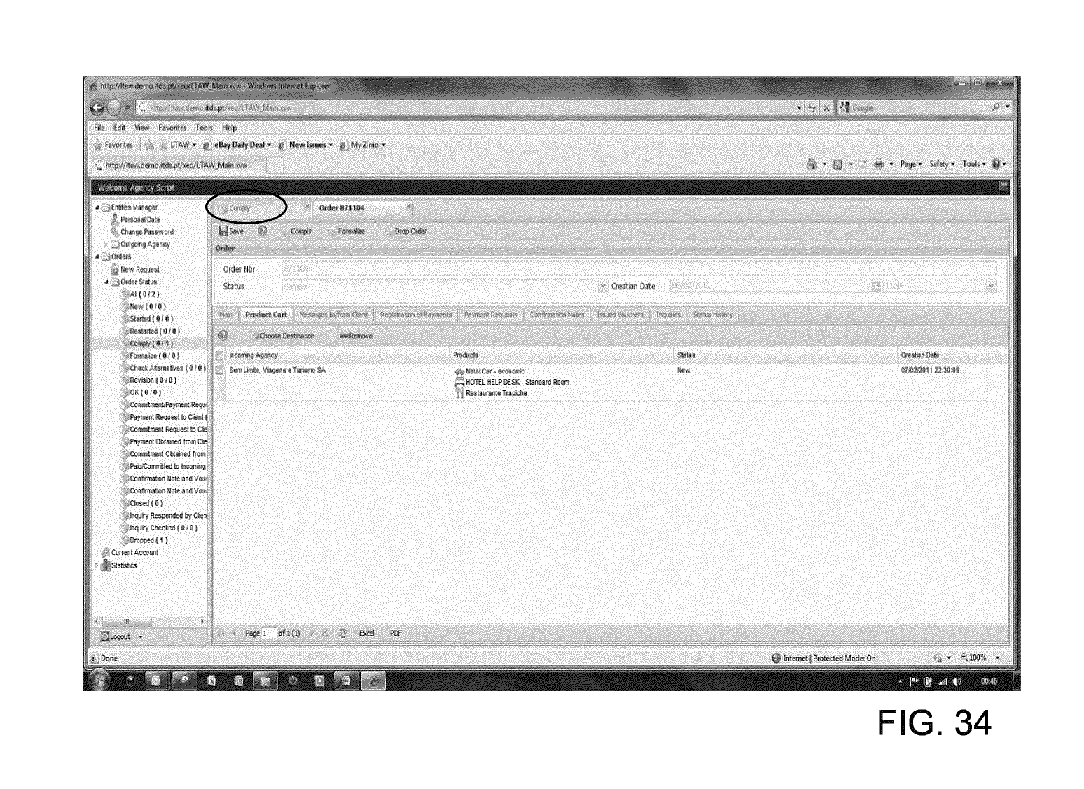

FIG. 34:

After all of the alterations have been made, click on “confirm”, to save.

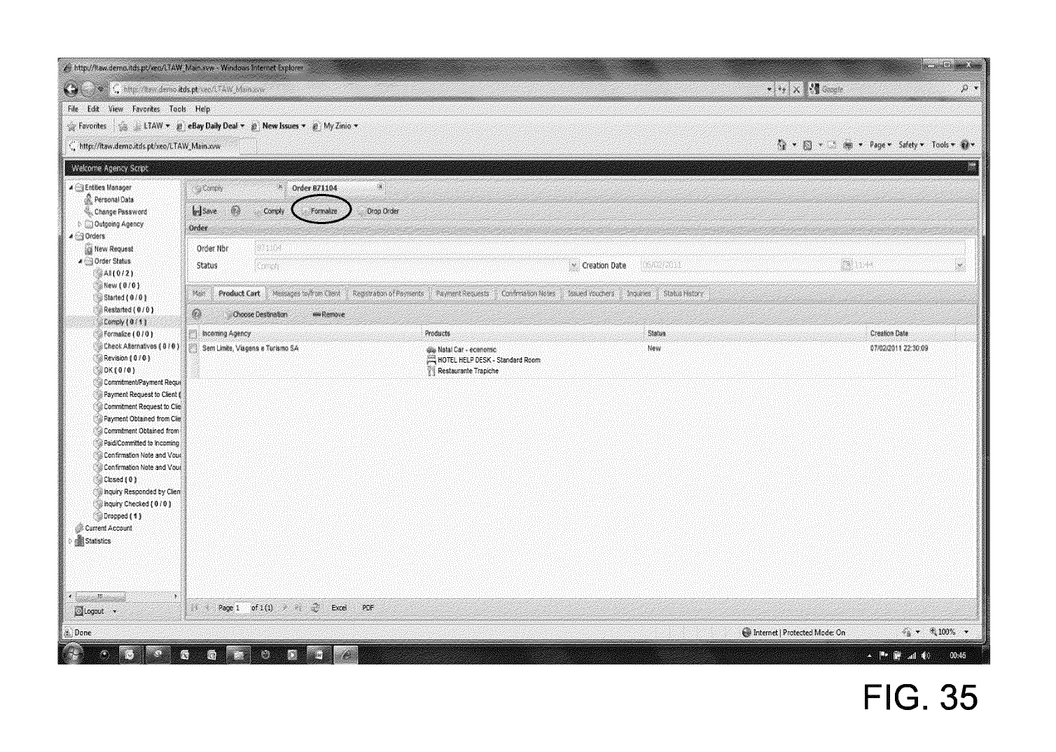

FIG. 35:

The “Comply” button must be pressed, for the amended proposal to be sent to the customer once more.

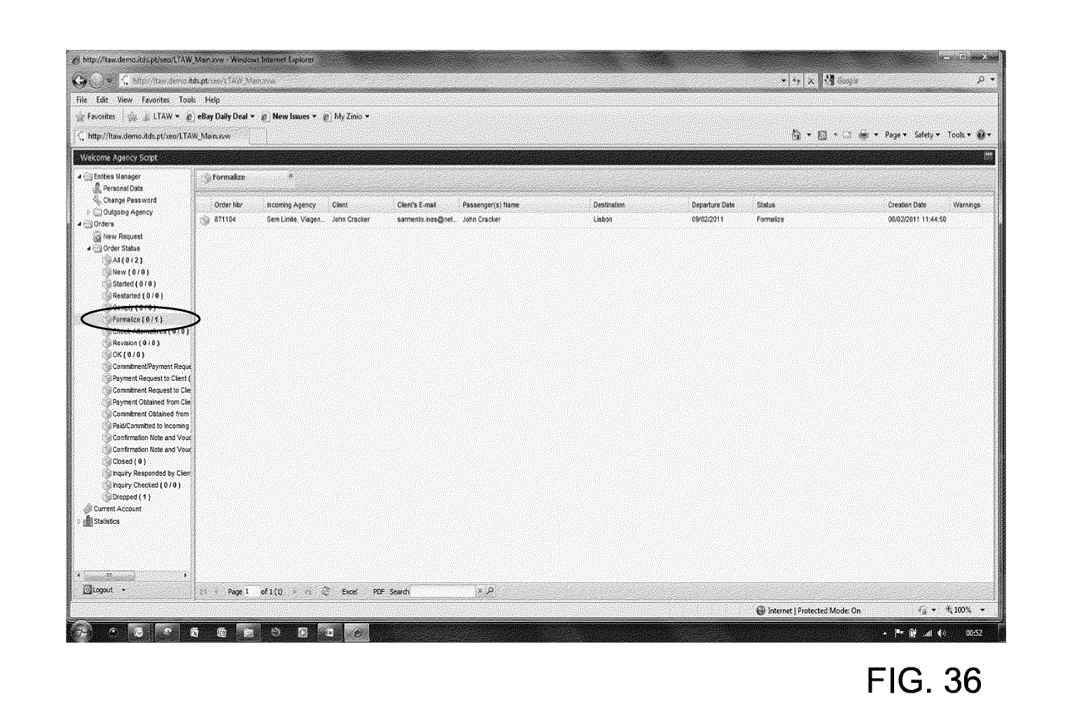

FIG. 36:

Once the customer has replied to the e-mail, agreeing with everything, the order is ready to be sent to the Incoming Agency. The previously described steps are repeated once more. After receipt of the email, the order is opened which can be fetched form the “Comply” folder or by the order number and then the “Formalize” button is clicked.

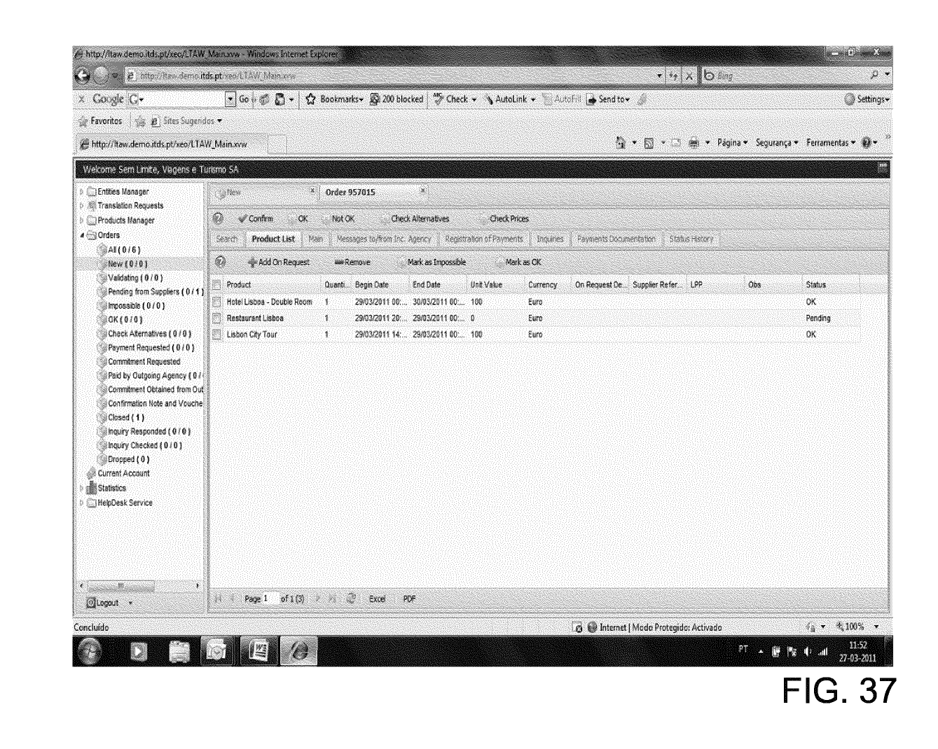

FIG. 37:

The order is received by the Incoming Agency, who checks on the availability of the desired products. While confirmation is not yet sent to the Outgoing Agency, the order remains in the “Formalize” folder.

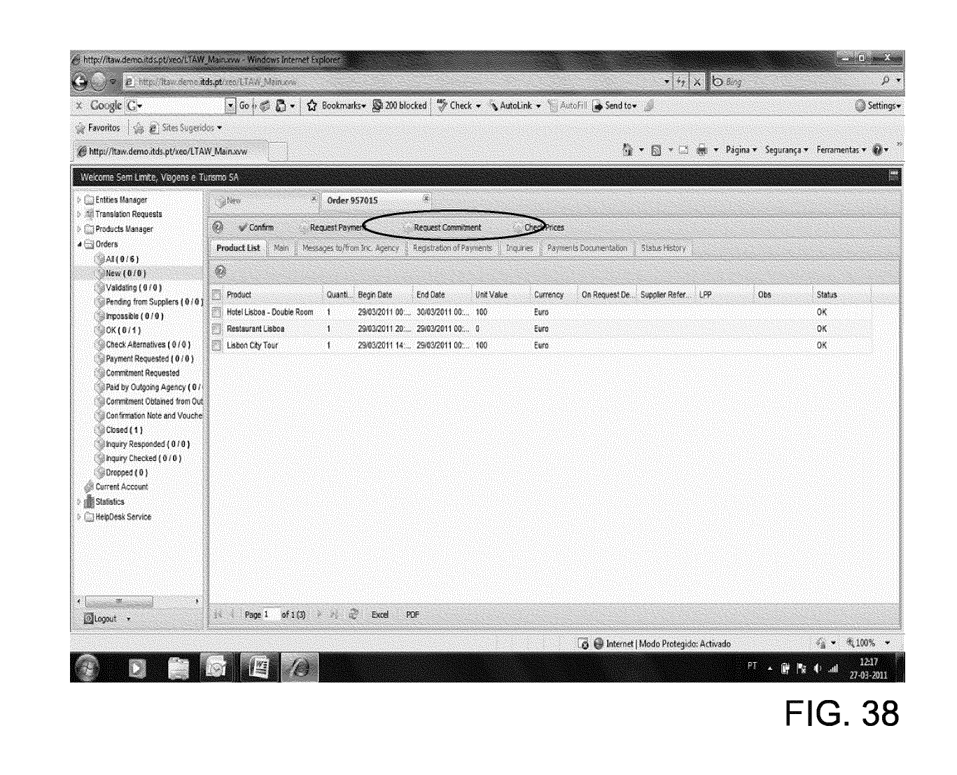

FIG. 38:

On the Incoming agency's side, the order is automatically placed in the folder marked “New”, and this agency follows a similar procedure to the one referred to above in relation to the Outgoing agency. On opening this folder and double-clicking on the line where the order is displayed, and then opening the order, a button marked “Validating” appears. By clicking on this button, the system automatically verifies if each one of the products is available and in stock, and if they are not, an e-mail is automatically sent to the supplier requesting the product/service. If there is more than 1 supplier, the system asks which supplier to select. If the product is in stock, an e-mail is also sent to the supplier, informing them of the sale and requesting that the sold unit be replaced. At this point, the system also verifies if the price of any of the requested products has changed; if the price is now lower, the system corrects the price accordingly and if there has been an increase, no change is made since the Portal guarantees that the prices initially quoted to the customer are maintained.

While awaiting the replies from suppliers guaranteeing that all of the products/services are available, the order is placed in the “Pending from suppliers” folder as it appears in FIG. 37. As can be seen, there are various buttons which allow the agent to record all of the possible alternative scenarios. Therefore, if the supplier's response is affirmative, the agent need only click on the line of that product and on the button “Mark as OK” and that product's status becomes “OK”. When all of the products have been marked “Ok”, the “OK” button is clicked once more and the order in the Outgoing agent's work station transfers automatically to the “OK” folder and in its workstation likewise.

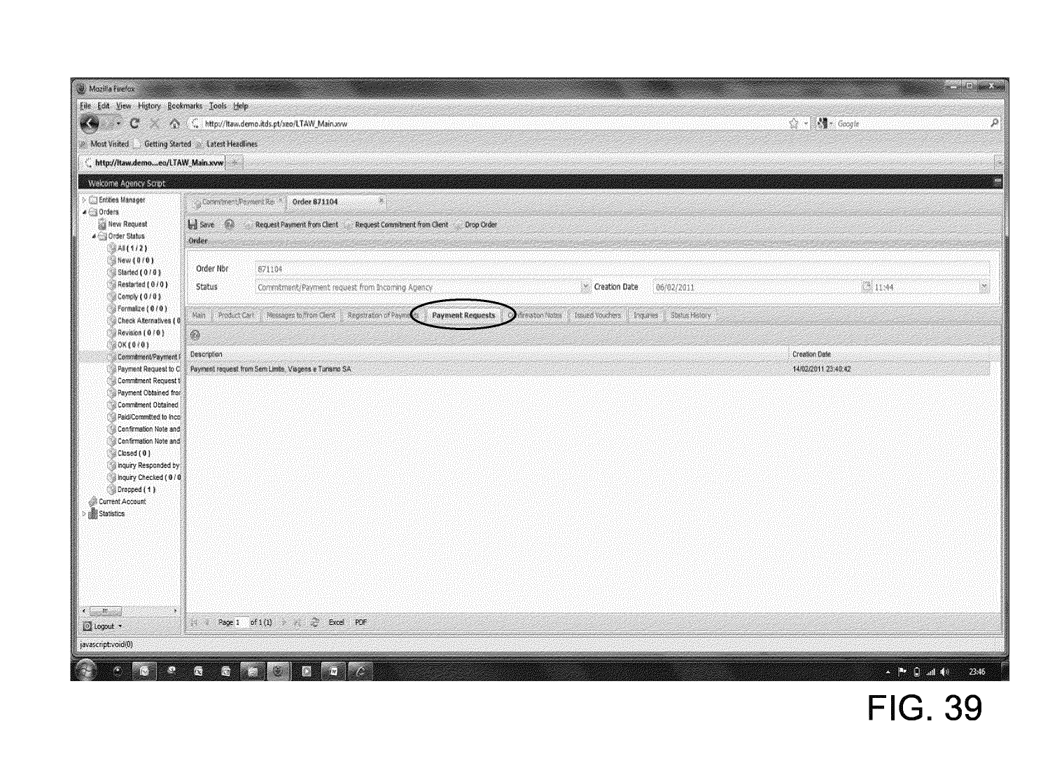

FIG. 39:

When the Incoming Agency deems appropriate, it requests payment from the Outgoing agency, unless credit is granted, in which case, the corresponding button is clicked, as can be seen in FIG. 37.

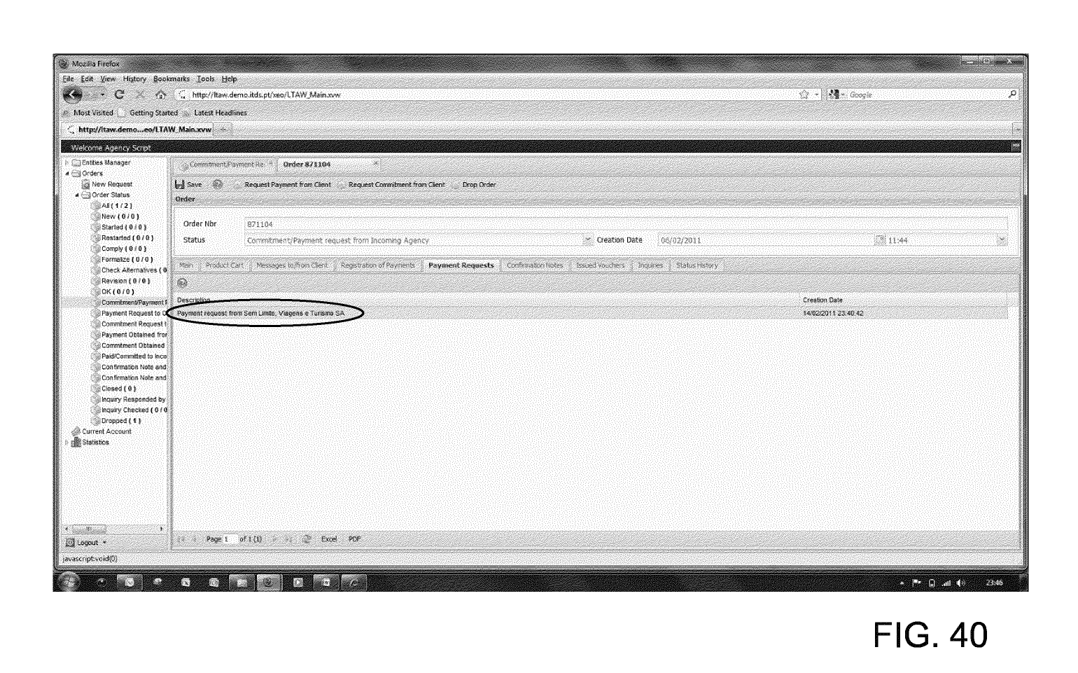

FIG. 40:

When the Incoming Agency actions “Payment Request” (it may also request a commitment only), the order transfers to the “payment Request from Incoming Agency” folder in the Outgoing agency's workbench. The request for payment can be viewed by the Outgoing agent in the “payment request” window in its workstation.

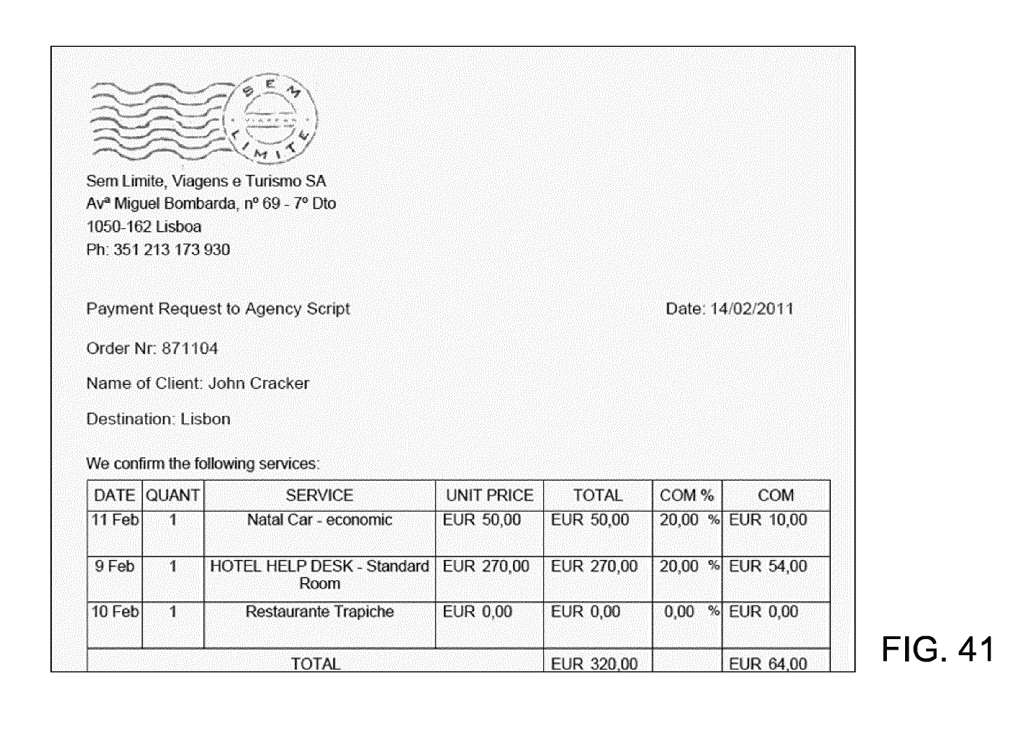

FIG. 41:

The Payment Request document may be viewed by double clicking on the description.

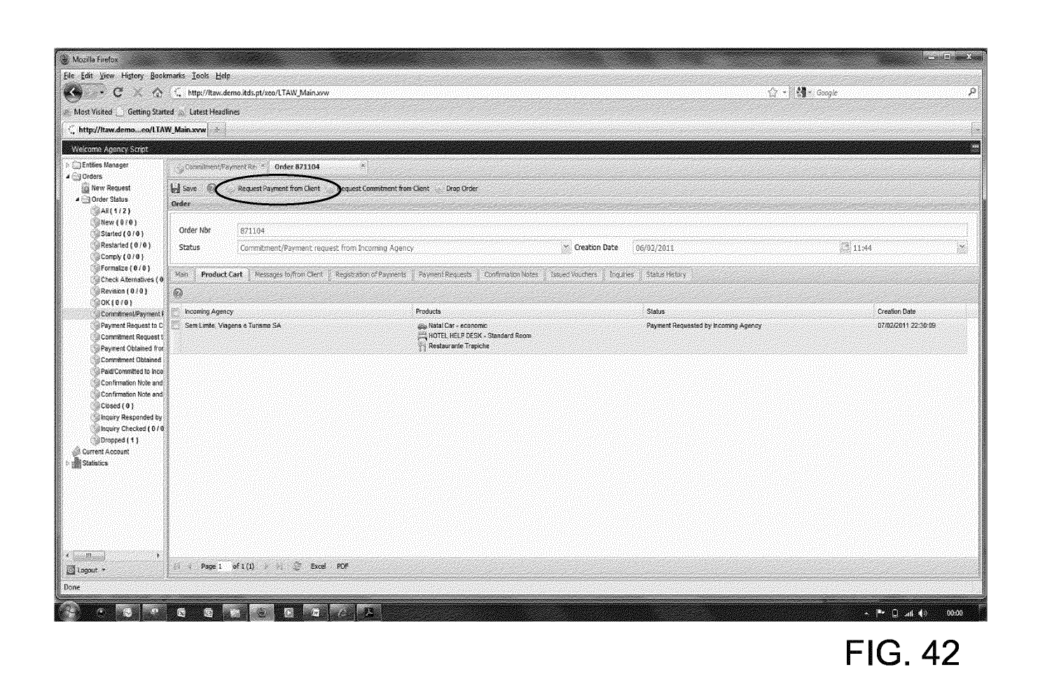

FIG. 42:

On view viewing the payment request, the Outgoing agency may verify the commission to which it is entitled.

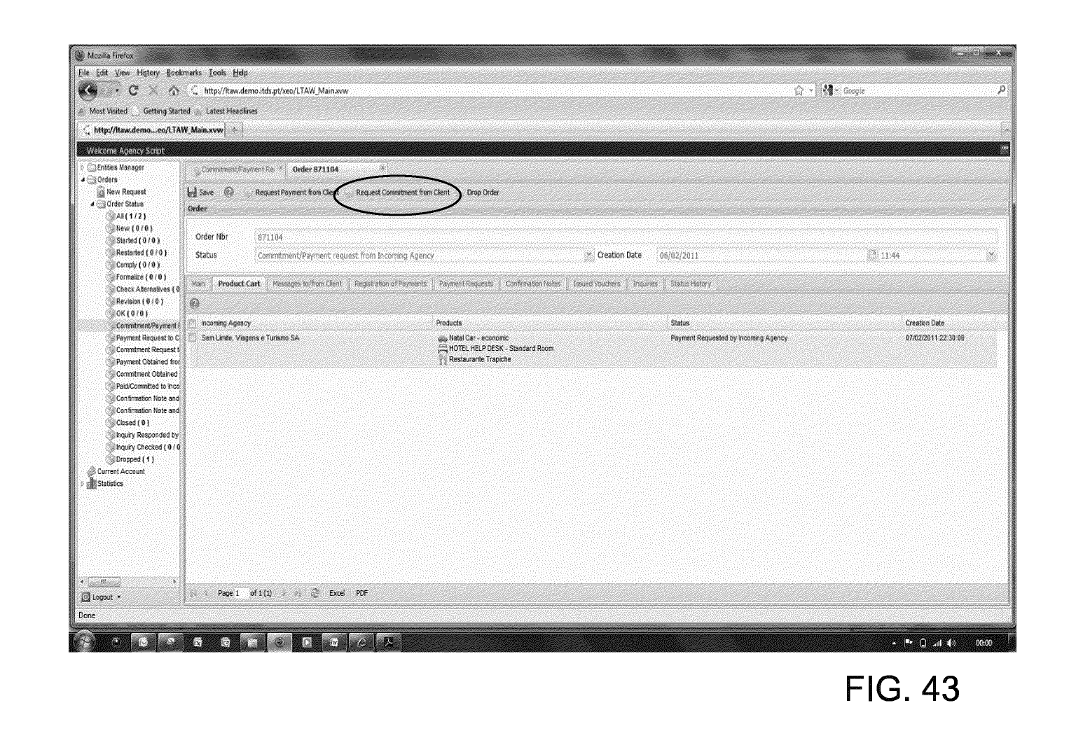

FIG. 43:

If everything is correct with the Incoming agency's request for payment from the Outgoing agency, the Outgoing agency requests payment from the final customer, by clicking on the “Request Payment from client” button. The customer then receives an e-mail with the payment request. Instead of requesting payment from customer, the agent can also request a payment commitment, if the customer has credit, by clicking on the “Request Commitment from client” button, whereupon the customer receives an e-mail with a payment commitment request.

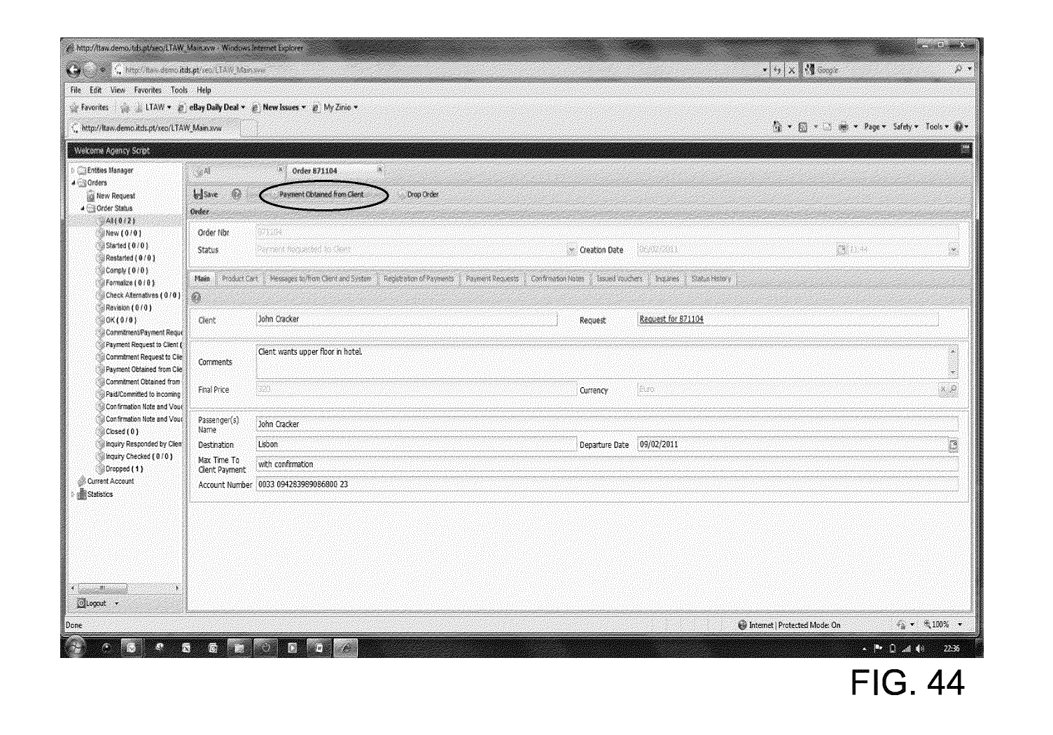

FIG. 44:

When payment is received from customer, the “Payment Obtained from client” button should be clicked, in the order file, in order for the system to consider the order paid.

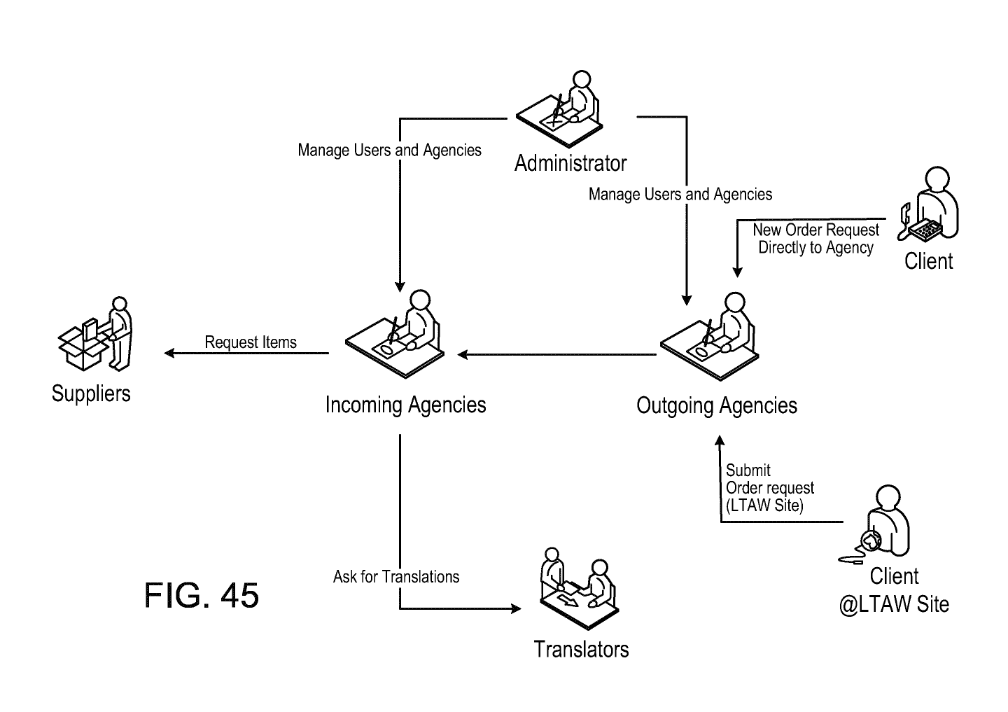

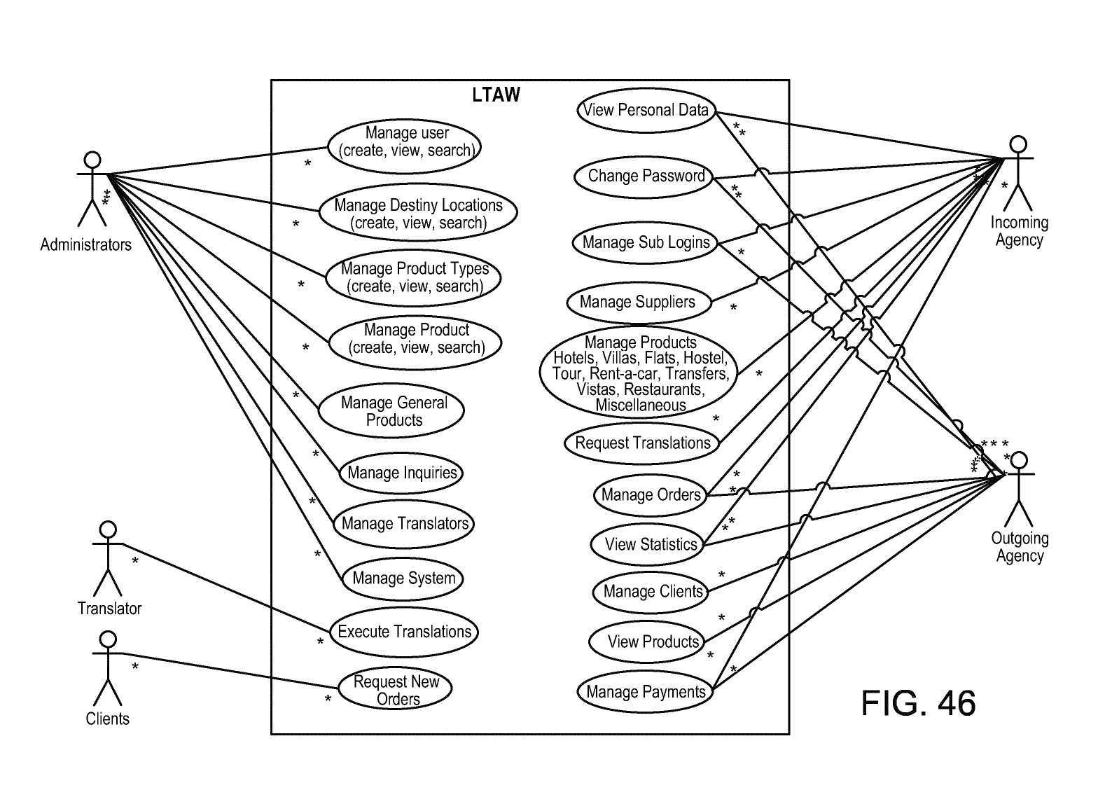

FIGS. 45 and 46 show charts depicting the relations and information/data flow between the interacting members of the present invention.

1. A method used in a Web Portal in which the final customer, rather than choose directly from an offer which is available on the site, indicates that he/she wishes to receive a proposal and quotation for what he/she is looking for and have the possibility of acquiring the products/services that are proposed.

2. Method of claim 1 by which, in the Portal, four different entities participate to conclude the business transaction, namely; final customer, specialist in organizing travel to other destinations (the Outgoing agency), the specialist in organizing travel in the market in which it operates (Incoming agency) and the final service provider (hotels, restaurants, rent a cars, etc.).

3. The method of claim 1 used in the Portal which permits the final customer to purchase all of the services/products he/she needs at the end destination, as well as to receive all of the information desired to be able to enjoy the trip more.

4. The method of claim 1 used in the Portal, whereby only the information which offers the greatest cost/benefit is displayed, and not an abundance of existing offers, as well as allowing such information to be classified according to different aspects.

5. The method of claim 1 used in the Portal, where by means of a click, the information required to conclude the transaction is successively sent from one participant to another.

6. The method of claim 1 used in the Portal, which defends the interests of the final consumer, due to:
motivating the Outgoing agency presenting the proposal to provide good service, given that the higher the level of satisfaction of the final customer, the more requests that will be sent to it by the Site.
motivating the Incoming agencies to propose good products at good prices as they will be competing with other agencies in the same destination market. In addition, because the site will display, in a very transparent manner, in relation to each service/product, their respective characteristics, price, and the level of satisfaction of final clients who previously used/purchased them. Similarly, these agencies also have to provide a first rate service in as much as they will evaluated by the Outgoing agencies and said evaluation is made available to Outgoing agencies when the time comes for them to select an Incoming agency.
24 h customer support at the end destination.

7. The method of claim 1 used in the Portal, to promote only such part of the offer that has the best cost/benefit ratio and, which further allows it to be an important sales channel for the services/products it promotes and thereby have good prices from its final suppliers and consequently, offer good prices to the final customer.

8. The method of claim 1 used in the Portal, enabling whoever introduces products/services, with an additional cost, to request that automatic translations be reviewed by native translators.

9. The method of claim 1 used in the Portal, allowing the Outgoing agency to invoice the final customer in any local currency, by merely indicating the exchange rate, in relation to the Dollar or Euro, they wish to use.

10. The method of claim 1 used in the Portal, whereby products rated below 6 on a scale from 1 to 10 must be removed from the Portal, as another means of quality assurance.

11. The method of claim 1 used in the Portal, wherein each proposal shall be accompanied by a description of the destination indicating, among other things, what is fundamental to see and do.

12. The method of claim 1 used in the Portal, in which the final customer pays the Outgoing agency, the Outgoing agency pays the Incoming agency and the latter pays the service provider.

13. The method of claim 1 used in the Portal of distribution of requests received through the Site among Incoming agencies and which takes into consideration the rating attributed by the agencies and by final customers and the traffic each agency brings to the Portal.

14. The method of claim 1 used in the Portal that permits Outgoing agencies to select the Incoming agency with which it will work on a given order, included in the table below containing the different Incoming agencies selected for that destination and a series of columns with the information required for a decision to be made.

15. The method of claim 1 used in the Portal allowing Outgoing agencies, after having chosen the Incoming agency, to visualize the types of services/products the agency can provide and that results from, with a click on the name of the selected agency, having access to the following table in which they are listed.

16. The method of claim 1 used in the Portal to allow Outgoing agencies, after having selected the Incoming agency, and having viewed the types of services/products the latter can provide, with a mere click, to see a table with the services/products available in that group, classified according to various aspects, with information on each one displayed, in some cases, by means of specific symbols, as can be seen in the table below.

17. The method of claim 1 used in the Portal that allows Outgoing agencies, after selecting the Hotel, to see the types of rooms available and the price for the intended stay, and which consists of clicking on the name of the hotel, after which the following information is displayed, when the hotel has no rooms available for that date, a red “X” appears.

18. The method of claim 1 used in the Portal allowing Outgoing agencies, after having selected the type of hotel room and before confirming their selection, to view, in detail, the information on the chosen hotel and room, as well as the information that will be sent to the final customer for confirmation or rejection of the Outgoing agency's selection by clicking on the name of the selected room, whereupon, a table with information immediately appears.

19. The method of claim 1 used in the Portal that allows price comparison with other sites and which consists of clicking on the “search sites” button and selecting one to view from the list displayed, whereupon the Portal automatically links to the selected site.

20. The method of claim 1 used in the Portal to confirm the choice of service/product and integrate it in the proposal to be made to the final customer and which consists of clicking on the “Add to Cart” button found in the previous table.

21. The method of claim 1 used in the Portal, by which, after all of the services/products have been selected by the Outgoing agency and proposed to final customer, an e-mail is automatically sent to the customer with a proposal which includes a brief description of the destination and of the proposed products/services and for which, in the order file, it is only necessary to click on the “Comply” button.

22. The method of claim 1 used in the Portal to add additional information to the product/service by clicking on the product name in the “Product List” and making a selection in the window that opens.

23. The method of claim 1 used in the Portal to identify orders that have actions pending wherein the order is placed automatically in several folders, from the moment it is received until it is executed, according to the phase it is in and as the agency knows which folders contain actions to be executed, it is easy for them to identify the orders that need to be handled, especially since, following its name, there are two numbers, wherein the second indicates the number of orders that are in the folder, as can be seen in the following figure.

24. The method of claim 1 used in the Portal to identify orders which have pending actions overdue and wherein each folder has two numbers, following its name, the first of which indicates the number of orders for which actions are overdue.

25. The method of claim 1 used in the Portal, whereby, if at the end of the trial period, the agency agrees with the proposed price, it will pay this amount from the first day it joined and if it does not agree, there is nothing to pay and it may use the system for a further 15 days free of charge.
